(19) United States
(12) Patent Application Publication
(10) Pub. No.: US 2013/0054279 A1
(43) Pub. Date: Feb. 28, 2013

(54) Method and System for Reserving and Allocating Vehicle Seating (Skycouch)

(71) Applicants: David Desmond Sharp, Auckland (NZ); David Charles Meaclem, Auckland (NZ); Richard Vernon Gill, Whangaparaoa (NZ)

(72) Inventors: David Desmond Sharp, Auckland (NZ); David Charles Meaclem, Auckland (NZ); Richard Vernon Gill, Whangaparaoa (NZ)

(73) Assignee: Air New Zealand Limited, Auckland (NZ)

(21) Appl. No.: 13/510,882

(22) PCT Filed: Nov. 19, 2010
(86) PCT No.: PCT/IB2010/055283

§ 371 Date: Nov. 5, 2012

(30) Foreign Application Priority Data
Nov. 19, 2009 (AU) 2009905662
Jan. 25, 2010 (AU) 2010900273

(51) Int. Cl. G06Q 10/02; G06Q 50/10

(52) U.S. Cl. 705/5

(57) ABSTRACT

A system and method for allocating aircraft seats for a flight reservation for a flight on an aircraft, wherein there is an inventory of seats for the flight, the system comprising a computer system configured to: receive a reservation request for one or more associated passengers for a flight on the aircraft, step 4009 receive a request for a couch-style seating space for those passengers, step 4011 said couch-style seating being nominally set aside as or configured or configurable as a multi-person seating space, allocating one or more of the associated passengers to the couch-style seating space for the flight, step 4012.

### FIELD OF THE INVENTION

The present invention relates to a method of reserving vehicle seating and a method of allocating vehicle seating, particularly but not solely for an aircraft, though it may also be applicable to other vehicles, such as but not limited to buses, trains, boats or similar.

The present invention further relates to a method of allocation of a vehicle seat, as well as a method of reservation of a vehicle seat. More particularly but not exclusively it relates to a computer implemented of allocation of a passenger vehicle seat, as well as a method of reservation of such a seat.

### BACKGROUND TO THE INVENTION

Currently many aircraft seating arrangements are known for use in commercial airliners. Commercial airlines typically aim to optimise seating on their aircraft to increase the comfort of passengers, while allowing for the greatest density of passengers per unit of floor area or for a given aircraft cabin volume. Aircraft especially are known for including arrayed rows of seats for passengers.

Further, airlines may also aim to provide flexibility in their seating arrangement. This may be useful, for example, where the seats of a particular flight are not fully booked, and the seating may be rearranged for better comfort of the passengers that are present on the aircraft. Arm rests may fold up to allow a passenger to stretch out across two or more adjacent seats if those seats are not occupied by other passengers. Such a variable seating arrangement may be particularly attractive to a class of passengers, such as a family travelling together, or a couple travelling together. The availability of such a variable seating arrangement may then be used to leverage marketing to these classes of passengers.

Airlines in particular have to balance the limitations of high fuel costs against customer demand and the effect of their reputation if a flight s cancelled.

Where there is not sufficient customer demand exists for a flight, it is not good for an airline's reputation to cancel flights. It is desirable for airlines to find a way of making such flights more commercially viable without cancelling the flight. Empty seats on flights do not make revenue for an airline, and sets of three or more are typically used as beds by passengers on the flight once it is established by them that these seats are empty.

Such empty seats are normally allocated on a first come-first serve basis, and is not organised into any specific order of priority.

It would be desirable for airlines to be able to create more revenue from these unreserved seats.

### SUMMARY OF THE INVENTION

The object of the present invention is to provide a method of allocation and reservation of vehicle seating that at least partially overcomes disadvantages of the prior art or at least provides the public with a useful choice.

For the purposes of interpretation of this specification and any claims based on it, when a series of steps in a method are described, the steps are not necessarily required to be in chronological order. Additionally any further steps described can be inserted between or with any of the other steps mentioned.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

In one aspect the present invention may be said to consist in a method of allocating aircraft seats for a flight reservation for a flight on an aircraft, the method comprising: receiving a reservation request for one or more associated passengers for a flight on the aircraft, receiving a request for at least one multi-person seating space for those passengers, wherein a multi-person seating space comprises at least 3 contiguous seats, allocating one or more of the associated passengers to a respective seat in a multi-person space (or to the multi-person seating space as a unit) resulting in a seat allocation for the associated passengers comprising at least one multi-person seating space with at least one more seat (spare seat) than the number of passengers allocated to seats in that multi-person seating space, and allowing the associated passengers exclusive use of the multi-person seating space during the flight.

Preferably, the method further comprises an inventory of seats for the flight wherein the at least one spare seat is removed from the inventory of seats.

Preferably, the allocation takes place at or near the time of receiving a booking request.

Preferably, the request for at least one multi-person seating space can be received any time prior to check-in.

Preferably, the allocation takes place prior to check-in.

Preferably, the removing of the one or more spare seats from the inventory prevents allocation of those one or more seats to passengers making future flight reservations on the aircraft flight.

Preferably, the method further comprises providing a ticket for the flight, the ticket specifying the passengers and identifying the multi-person seating space.

Preferably, the method further comprises receiving a check-in request, providing a boarding pass to each of the associated passengers, each boarding pass showing the seat in the multi-person seating space allocated to the respective passenger, and optionally identifying the multi-person seating space.

Preferably, the multi-person seating space comprises three or more seat pans configured such that a passenger can lie across the seat pans substantially unimpeded.

Preferably, one or more of the seats in the multi-person seating space can be configured with one or more extension surfaces substantially co-planar with each seat pan, which, in combination with the seat pans, provide additional support surface for the associated passengers.

Preferably, allocating associated passengers to a seat in a multi-person space nominally allocates the multi-person seating space to those passengers.

Preferably, three contiguous seats comprising a multi-person seating space are physically configured to form the multi-person seating pace.

Preferably, three contiguous seats comprising a multi-person seating space are nominally set aside as a multi-person seating space for nominal allocation to one or more passengers upon request.

Preferably, the aircraft comprises a plurality of seats, wherein a first portion of the seats are physically configured as a plurality of multi-person seating spaces, and a second portion of the seats are individual seats for individual allocation, the method comprising: receiving reservation requests along with respective requests for a multi-person seating space and allocating passengers relating to those requests to seats in a respective multi-person seating space, receiving reservation requests without requests for a multi-person seating space and allocating passengers relating to those reservation requests to individual seats, or, if all the individual seats have been allocated, allocating those passengers to seats in a multi-seat seating space.

In another aspect the present invention may be said to consist in a system for allocating aircraft seats for a flight reservation for a flight on an aircraft comprising: a computer system configured to: receive a reservation request for one or more associated passengers for a flight on the aircraft, receive a request for at least one multi-person seating space for those passengers, wherein a multi-person seating space comprises at least 3 contiguous seats, and allocate one or more of the associated passengers to a respective seat in a multi-person space (or to the multi-person seating space as a unit) resulting in a seat allocation for the associated passengers comprising at least one multi-person seating space with at least one more seat (spare seat) than the number of passengers allocated to seats in that multi-person seating space, the associated passengers having exclusive use of the multi-person seating space during the flight.

Preferably, the method further comprises a database with an inventory of seats for the flight wherein the computer system is configured to remove the at least one spare seat from the inventory of seats.

Preferably, the allocation takes place at or near the time of receiving a booking request.

Preferably, the computer system allocates seats at or near the time of receiving a booking request.

Preferably, the computer system allocates seats prior to check-in.

Preferably, the removing of the one or more spare seats from the inventory prevents allocation of those one or more seats to passengers making future flight reservations on the aircraft flight.

Preferably, the computer system generates ticket for the flight, the ticket specifying the passengers and identifying the multi-person seating space.

Preferably, the method further comprises a computer system configured to: receive a check-in request, provide a boarding pass to each of the associated passengers, each boarding pass showing the seat in the multi-person seating space allocated to the respective passenger, and optionally identifying the multi-person seating space.

Preferably, the multi-person seating space comprises three or more seat pans configured such that a passenger can lie across the seat pans substantially unimpeded.

Preferably, one or more of the seats in the multi-person seating space can be configured with one or more extension surfaces substantially co-planar with each seat pan, which, in combination with the seat pans, provide additional support surface for the associated passengers.

Preferably, allocating associated passengers to a seat in a multi-person space nominally allocates the multi-person seating space to those passengers.

Preferably, three contiguous seats comprising a multi-person seating space are physically configured to form the multi-person seating pace.

Preferably, three contiguous seats comprising a multi-person seating space are nominally set aside as a multi-person seating space for nominal allocation to one or more passengers upon request.

Preferably, the aircraft comprises a plurality of seats, wherein a first portion of the seats are physically configured as a plurality of multi-person seating spaces, and a second portion of the seats are individual seats for individual allocation, the computer system being further configured to: receive reservation requests along with respective requests for a multi-person seating space and allocating passengers relating to those requests to seats in a respective multi-person seating space, receive reservation requests without requests for a multi-person seating space and allocating passengers relating to those reservation requests to individual seats, or, if all the individual seats have been allocated, allocating those passengers to seats in a multi-seat seating space.

In another aspect the present invention may be said to consist in a method of allocating passengers to multi-person seating spaces for a flight reservation for a flight on an aircraft, wherein each multi-person seating space comprises three or more seat pans that can be configured with one or more extension surfaces substantially co-planar with each seat pan, which, in combination with the seat pans, provide additional support surface for the associated passengers, the method comprising: receiving a reservation request for one or more associated passengers for a flight on the aircraft, receiving a request for at least one multi-person seating space for those passengers, allocating one or more of the associated passenger to a respective seat in a multi-person space, or to the multi-person seating space as a unit.

Preferably, if there are one or more seats in the multi-person space not allocated to the passengers, removing the one or more spare seats from the inventory of seats.

In another aspect the present invention may be said to consist in a system for allocating passengers to multi-person seating spaces for a flight reservation for a flight on an aircraft, wherein each multi-person seating space comprises three or more seat pans that can be configured with one or more extension surfaces substantially co-planar with each seat pan, which, in combination with the seat pans, provide additional support surface for the associated passengers, the system comprising a computer system configured to: receive a reservation request for one or more associated passengers for a flight on the aircraft, receive a request for at least one multi-person seating space for those passengers, allocate one or more of the associated passenger to a respective seat in a multi-person space, or to the multi-person seating space as a unit.

In another aspect the present invention may be said to consist in a method of allocating aircraft seats for a flight reservation for a flight on an aircraft, wherein there is an inventory of seats for the flight, the method comprising: receiving a reservation request for one or more associated passengers for a flight on the aircraft, receiving a request for a couch-style seating space for those passengers, said couch-style seating being nominally set aside as or configured or configurable as a multi-person seating space, allocating one or more of the associated passengers to the couch-style seating space for the flight.

Preferably, the couch-style seating space comprises three or more seat pans configured such that a passenger can lie across the seat pans substantially unimpeded.

In another aspect the present invention may be said to consist in a system for allocating aircraft seats for a flight reservation for a flight on an aircraft, wherein there is an inventory of seats for the flight, the system comprising a computer system configured to: receive a reservation request for one or more associated passengers for a flight on the aircraft, receive a request for a couch-style seating space for those passengers, said couch-style seating being nominally set aside as or configured or configurable as a multi-person seating space, allocating one or more of the associated passengers to the couch-style seating space for the flight.

Other aspects of the invention are set out below.

In one aspect the invention may be said to broadly consist in a method of allocating space for a journey comprising:
receiving a journey booking for a multi-person space suitable for accommodating a plurality of passengers during a journey, the booking being for one or more passengers,
reserving the multi-person space for the one or more passengers,
issuing a journey ticket associated with the multi-person space for one, some, or all of the passengers.

Preferably, the method further comprises offering the multi-person space for reservation as a single space for one or more passengers.

Preferably the multi-person space is 2 or more guaranteed contiguous adjacent seats.

Optionally, the multi-person space is reserved as a single unit against the one or more passengers.

The multi-person space comprises a plurality of passenger locations. Preferably, the number of passengers is less than the number of passenger locations in the multi-person space, resulting in one or more spare passenger locations. Preferably, only one ticket is issued to each passenger. There might not be an independent ticket issued for each seat. Preferably, where the number of passengers is less than the number of passenger locations in the multi-person space, the number of issued journey tickets associated with the multi-person space is less than the number of passenger locations.

Optionally, each journey ticket is also associated with one or more passenger locations in the multi-person space. Preferably, the booking comprises a primary passenger, wherein the journey ticket of the primary passenger is associated with the one or more spare passenger locations.

Preferably, the revenue associated with the one or more spare passenger locations is associated with the journey ticket of the primary passenger

Preferably, each passenger location is a seat.

Preferably the method further comprises issuing a boarding pass associated with the multi-person space for each passenger.

Optionally, each boarding pass is also associated with one or more passenger locations in the multi-person space. Preferably, the boarding pass of the primary passenger is associated with the one or more spare passenger locations.

Preferably, any spare passenger location is removed from inventory in the booking system.

Preferably, the multi-person space comprises two, three, four or more adjacent seats or otherwise adjacent and/or contiguous passenger locations.

Preferably, the multi-person space, and/or the seats in the multi-person space, can be configured into a bed.

In another aspect the invention may be said to broadly consist in a system for booking space for a journey comprising, the system comprising a booking system adapted to:
receive a journey booking for a multi-person space suitable for accommodating a plurality of passengers during a journey, the booking being for one or more passengers,
reserve the multi-person space for the one or more passengers,
issue a journey ticket associated with the multi-person space for one, some, or all of the passengers.

Preferably, the system is further adapted to offer the multi-person space for reservation as a single space for one or more passengers, through a user interface.

Preferably the multi-person space is 2 or more guaranteed contiguous adjacent seats.

Optionally, the multi-person space is reserved as a single unit against the one or more passengers.

The multi-person space comprises a plurality of passenger locations. Preferably, the number of passengers is less than the number of passenger locations in the multi-person space, resulting in one or more spare passenger locations. Preferably, only one ticket is issued to each passenger. There might not be an independent ticket issued for each seat. Preferably, where the number of passengers is less than the number of passenger locations in the multi-person space, the number of issued journey tickets associated with the multi-person space is less than the number of passenger locations.

Optionally, each journey ticket is also associated with one or more passenger locations in the multi-person space. Preferably, the booking comprises a primary passenger, wherein the journey ticket of the primary passenger is associated with the one or more spare passenger locations.

Preferably, the revenue associated with the one or more spare passenger locations is associated with the journey ticket of the primary passenger

Preferably, each passenger location is a seat.

Preferably the system is further adapted to issue a boarding pass associated with the multi-person space for each passenger.

Optionally, each boarding pass is also associated with one or more passenger locations in the multi-person space. Preferably, the boarding pass of the primary passenger is associated with the one or more spare passenger locations.

Preferably, any spare passenger location is removed from inventory in the booking system.

Preferably, the multi-person space comprises two, three, four or more adjacent seats or otherwise adjacent and/or contiguous passenger locations.

Preferably, the multi-person space, and/or the seats in the multi-person space, can be configured into a bed.

According to a further aspect, the invention may be said to broadly consist in a method of reserving seats comprising the steps of
accepting a request for the reservation of at least one primary seat;
offering customers an option to book an adjacent seat if one is available;
storing linking information associated with a plurality of sets of primary and adjacent seats;
finalizing allocation of the adjacent seats on the basis of a comparison of linking information associated with one set of primary seat and adjacent seat against passenger information associated with linking information associated with another set of primary seat and adjacent seat.

Preferably, the method is performed by a computer system.

According to a further aspect, the invention may be said to broadly consist in a method of reserving seats comprising the steps of
accepting a request for the reservation of at least one primary seat;
offering customers an option to book an adjacent seat if one is available;
storing linking information associating the primary seat with the adjacent seat and passenger information;
determining the priority of allocation of adjacent seats against primary seats;
wherein the primary and associated adjacent seats are together reconfigurable to provide a horizontal sleeping surface.

Preferably, the primary and associated adjacent seats are configurable between individual single seat configurations and a horizontal double bed configuration on which two passengers can lay side by side.

Preferably, the method includes the step of terminating further reservation of primary seats at a cutoff time.

Preferably, the method includes the step of allocating primary and adjacent seats for optimization of one or more selected from passenger comfort and commercial profit.

Preferably, the method is performed by a computer system.

According to a further aspect, the invention may be said to broadly consist in a method of reserving seats comprising the steps of
accepting a request for the reservation of at least one primary seat;
offering customers an option to book an adjacent seat if one is available;
storing linking information associating the primary seat with the adjacent seat and passenger information;
terminating further reservation of primary seats at a cutoff time; and
allocating primary and adjacent seats according to an optimized pattern wherein the primary and associated adjacent seats are optimized for one or more selected from passenger comfort and commercial profit.

Preferably, the allocation of the adjacent seats can be carried out on the basis of a comparison of passenger information associated with one primary seat against passenger information associated with another primary seat.

Preferably, the linking information includes a bid submitted by a customer.

Preferably, the bid is of a monetary value.

Preferably, the bid is associated with a primary seat and adjacent seat.

Preferably, the allocation of the adjacent seats can be carried out on the basis of a comparison of bids.

Preferably, the bid can be input by a customer on purchase of the ticket.

Preferably, the bid can be updated by a customer after initial reservation of the adjacent seat and primary seat.

Preferably, the bid can be updated online.

Preferably, the bid can be updated online up until a cutoff time.

Preferably, the method is performed by a computer system.

According to a further aspect, the invention may be said to broadly consist in a method of reserving seats comprising the steps of
accepting a request for the reservation of at least one primary seat;
offering customers an option to book an adjacent seat if one is available;
storing linking information associating the primary seat with the adjacent seat and passenger information;
allocating primary and adjacent seats according to an optimized pattern as at the time of reservation of the primary and associated adjacent seats, wherein the primary and associated adjacent seats are optimized for one or more selected from passenger comfort and commercial profit.

According to one aspect, the invention may be said to broadly consist in a method of allocating vehicle tandem seating comprising the steps of
interrogating a seat bookings database of stored seating information for information relating to the availability of a pair of primary seats in a seating configuration of a vehicle for an event;
receiving passenger information indicative of a pair of passenger's details;
storing linking information linking the primary seats with said passenger information to thereby assign said primary seats to said passengers;
interrogating a seat bookings database of stored seating information for information relating to the availability of at least one adjacent seat adjacent to the primary seats;
storing linking information linking the adjacent seat(s) to one or more selected from
   said passenger information; and
   said primary seat;
wherein the linking information linking the adjacent seat(s) to one or more selected from said passenger information; and said primary seat, is a bid indicative of a monetary value.

Preferably, the method includes the step of comparing the monetary value of a bid of stored linking information of a passenger against the monetary value of a bid of stored linking information of a passenger.

Preferably, the method includes the step of finalizing allocation of an adjacent seat to a passenger according to the results of the comparison.

According to one aspect, the invention may be said to broadly consist in a method of allocating vehicle tandem seating comprising the steps of
interrogating a seat bookings database of stored seating information for information relating to the availability of a pair of primary seats in a seating configuration of a vehicle for an event;
receiving passenger information indicative of a pair of passenger's details;
storing linking information linking the primary seats with said passenger information to thereby assign said primary seats to said passengers;
interrogating a seat bookings database of stored seating information for information relating to the availability of at least one adjacent seat adjacent to the primary seats;
storing linking information linking the adjacent seat(s) to one or more selected from
   said passenger information; and
   said primary seat;
wherein the said primary seats and said adjacent seat(s) are configurable between three single seats and a horizontal double bed on which two passengers can lay side by side.

Preferably, the primary seats and adjacent seats are reconfigurable by virtue of the fact that each seat includes a seat back, a seat pan and a foot rest, said foot rest moveably mounted relative to the seat pan to allow it to move between a stored condition and a extended condition where the seat pan and the foot rest cooperate to provide substantially horizontal passenger support

Preferably, the method includes the step of
transmitting a reservation instruction for changing the indicated availability of the primary seats as being reserved on the seating bookings database;

Preferably, the method includes the step of
transmitting a reservation instruction for changing the indicated availability of the adjacent seat as being reserved on the seat bookings database.

Preferably, the method may include the step of
interrogating a seating configuration database of stored seating information of a vehicle for an event, to check whether said primary seats and/or said adjacent seat are of a type configurable between three single seats and a horizontal double bed on which two passengers can lay side by side to return an affirmative or negative result.

Preferably, the method includes the step, in the event of receiving a negative result from the interrogation, further interrogating the seating configuration database to find a pair of primary seats and/or an adjacent seat.

Preferably, the method includes the step of recommending an alternative set of two primary seats and an adjacent seat.

Preferably, the step of recommending an alternative set of two primary seats and an adjacent seat comprises the step of transmitting a recommendation signal for the display of said recommendation.

Preferably, the method includes the step of:
receiving an instruction to link said adjacent seat(s) to one or more selected from
   said passenger information; and
   said primary seat.

According to a further aspect, the invention may be said to broadly consist in a method of allocating vehicle seating comprising the steps of
interrogating a seat bookings database of stored seating information for information relating to the availability of a primary seat in a seating configuration of a vehicle
receiving passenger information indicative of a passengers details;
storing linking information linking the primary seat with said passenger information to thereby assign said primary seat to said passenger;
interrogating a seat bookings database of stored seating information for information relating to the availability of at least one or more adjacent seats located directly adjacent to the primary seat;
storing linking information linking the adjacent seat(s) to one or more selected from
   said passenger information; and
   said primary seat;
wherein the said primary seats and said adjacent seat(s) are configurable together to provide a horizontal sleeping surface.

Preferably, the said primary seats and said adjacent seat(s) are configurable between a single seat configuration and a horizontal double bed configuration on which at least two passengers can lay side by side.

Preferably, the method includes the step of:
transmitting a reservation instruction for changing the indicated availability of a primary seat as being reserved;

Preferably, the method includes the step of:
receiving an instruction to link the passenger information with a primary seat selected from the stored seating information indicative of a seating configuration;

Preferably, the method includes the step of:
receiving an instruction to link said adjacent seat(s) to one or more selected from
   said passenger information; and
   said primary seat; and

Preferably, the method may include the step of
receiving a first interrogation instruction signal instruction to interrogate the seat bookings database for the availability of a primary seat before interrogating the seat bookings database for the availability of a primary seat;

Preferably, the method may include the step of
receiving a second interrogation instruction signal to interrogate the seat bookings database for the availability of an adjacent seat before interrogating the seat bookings database for the availability of the adjacent seat(s);

Preferably, the step of interrogating a seat bookings database of stored seating information to establish the availability of the primary seat and the adjacent seat(s) is carried out at the same time.

Preferably, the step of interrogating a seat bookings database of stored seating information for information relating to the availability of one selected from the primary seat and the adjacent seat(s) includes the steps of:
transmitting an interrogation signal to interrogate the seat bookings database; and
receiving a reply signal indicative of whether the requested seat is available in the affirmative or negative.

Preferably, the step of interrogating a seat bookings database of stored seating information for information relating to the availability of a seat in a seating configuration of a vehicle is by interrogation of a remote database.

Preferably, the remote database is the Galileo™ database.

Preferably, the method includes the step of
storing seating information indicative of a seating configuration in a vehicle in a seating configuration database.

Preferably, the method includes the step of
receiving an interrogation signal requesting confirmation of the linking of the adjacent seat(s) to one or more selected from
   said passenger information; and
   said primary seat;

Preferably, the step of storing linking information linking the primary seat with said passenger information to thereby assign said primary seat to said passenger includes the step of storing the passenger information and/or the primary seat information.

Preferably, the step of storing linking information stores the linking information in a seating reservations database.

Preferably, the linking information is one or more selected from
passenger details, such as
   name,
   nationality,
   loyalty club membership details;
   disabilities;
   passenger physical features;
information indicative of the adjacent seat number;
payment details; and
whether the passenger is travelling with small children.

Preferably, the payment details of the linking information may include a bid of a monetary value associated with one or more primary seats of a monetary value.

Preferably, the method includes
transmitting a confirmation signal confirming the linking of said adjacent seat(s) and said primary seat.

Preferably, the confirmation signal is of a protocol that may be printed as evidence of the linking of the primary seat and the at least one adjacent seat.

The method may include the steps of
transmitting a boarding card print signal suitable for allowing the printing of a boarding card indicating that the primary seat and the at least one adjacent seat is linked.

Preferably, the method includes the step of
transmitting a reservation confirmation signal to show that the primary seat has been reserved.

Preferably, the method includes the step of
transmitting a reservation confirmation signal to show that the adjacent seat(s) have been reserved.

Preferably, the reservation confirmation signal is transmitted to a remote terminal connected to the Internet.

Preferably, the method includes the step of:
interrogating a seating configuration database of stored seating information of a vehicle for an event, to establish whether said primary seat and/or said adjacent seat (“the proposed seats”) are of a type configurable together to provide a horizontal sleeping surface, to return an affirmative or negative result.

Preferably, the interrogation of the seating configuration database together is to establish whether said primary seat and/or said adjacent seat are of a type configurable between a single seat configuration and a horizontal double bed configuration.

Preferably, the method includes the step of, in the event of the return of a negative result from the interrogation to establish whether said primary seat and/or said adjacent seat (“the proposed seats”) are of a type configurable together to provide a horizontal sleeping surface,
recommending that an alternative set of seats of a similar number to the proposed set of seats be found that are of a type configurable between a single seat configuration and a horizontal double bed configuration.

Preferably, the method includes the step, in the event of receiving a negative result from the interrogation to establish whether said primary seat and/or said adjacent seat (“the proposed seats”) are of a type configurable together to provide a horizontal sleeping surface,
further interrogating the seating configuration database for an alternative set of seats of a similar number which are of a type configurable together to provide a horizontal sleeping surface to return an affirmative or negative result.

Preferably, the method includes the step of, in the event that an affirmative result is returned from the interrogation of the seating configuration database for an alternative set of seats of a similar number which are of a type configurable together to provide a horizontal sleeping surface,
calculating a preferred alternative set of seats.

Preferably, the method includes the step of calculating an alternative set of seats of a similar number in said vehicle so as to optimize one or more of:
passenger comfort;
passenger personal space;
commercial effect or viability.

Preferably, the method includes the step of recommending an alternative set of seats, of a similar number, to the proposed seats.

Preferably, the step of recommending an alternative set of seats of a similar number comprises the step of transmitting a recommendation signal for the display of said recommendation.

Preferably, the step of calculating an alternative set of seats is carried out to in accordance with an algorithm for the maximization of the number of available primary seats with unallocated seats around them that are available for use as adjacent seats.

Preferably, the method includes the step of:
transmitting information indicative of a recommended adjacent seat for display.

Preferably, the method includes the step of, in the event that a negative result is returned from the interrogation of the seating configuration database for an alternative set of seats of a similar number which are of a type configurable together to provide a horizontal sleeping surface,
comparing at least part of the linking information of the proposed seats with the linking information of a previously allocated set of primary and adjacent seats of a similar number.

Preferably, the linking information that may be compared is
passenger payment details;
whether passenger has already paid for the adjacent seat;
whether the passenger is a member of a loyalty program;
whether the passenger is travelling with children;
whether the passenger is listed as a being disabled or sick;
whether the adjacent seat was the last adjacent seat allocated.

Preferably, the comparison of the payment details of the linking information may include a comparison of a bid associated with one or more primary seats of a monetary value.

Preferably, the method includes one or more of the steps of
disallowing or allowing the cancelling of one or more of the linking information being compared in accordance with the result of the comparison.

Preferably, the method includes the step of:
comparing the current date and time with an assigned cutoff date and time;
preventing reallocation of the adjacent seats from the assigned cutoff date and time so that the adjacent seats cannot be reallocated as primary seats.

Preferably, the assigned cutoff date and time is generated automatically.

Alternatively, the assigned cutoff date and time is generated by reference to an event date and time.

Preferably, the event date and time is a flight.

Alternatively, the assigned cutoff date and time is generated by a user.

Preferably, the method includes the step of:
transmitting notification of the cutoff date being reached to a remote terminal.

According to a further aspect, the invention may be said to broadly consist in a method of reserving vehicle seating
transmitting an first interrogation instruction signal for interrogating a remote seat bookings database of stored seating information for the availability of a primary seat in a seating configuration of a vehicle for an event;
receiving a signal confirming the availability of the primary seat;
transmitting a booking signal instructing the reservation of the primary seat to thereby render it unavailable to others;
transmitting passenger information indicative of a passenger's details;
transmitting a second interrogation instruction signal for interrogating a remote seat bookings database of stored seating information for the availability of one or more adjacent seats in a seating configuration of a vehicle for an event,
transmitting passenger information to a remote terminal;
transmitting a linking storage signal instructing the remote storage of linking information linking the adjacent seat(s) to one or more selected from
   said passenger information; and
   said primary seat;
wherein said primary seat and said adjacent seats are configurable to together provide a horizontal sleeping surface.

Preferably, the method of reserving vehicle seating involves at least two primary seats and one adjacent seat, wherein primary seats and adjacent seat(s) are configurable between a single seat configuration and a horizontal double bed configuration on which at least two passengers can lay side by side.

Preferably, the method may include the step of:
receiving a signal confirming the availability of the adjacent seat(s);

Preferably, the method may include the step of:
transmitting a booking signal instructing the reservation of the adjacent seat(s) to thereby render it unavailable to others;

Preferably, the method may include the step of:
transmitting a linking storage signal instructing the remote storage of linking information linking the adjacent seat(s) to said primary seat.

Preferably, the linking information is one or more selected from
passenger details, such as
name,
nationality,
loyalty club membership details;
disabilities;
passenger physical features;
information indicative of the adjacent seat number;
payment details; and
whether the passenger is travelling with small children.

Preferably, the payment details of the linking information may include a bid of a monetary value.

Preferably, the booking signal instructing the reservation of the adjacent seat(s) is sent simultaneously with the linking storage signal.

Preferably, the method includes the step of
receiving a reservation confirmation signal confirming the reservation of the primary seat and adjacent seat(s)

Preferably, the method includes the step of
transmitting a print signal for printing confirmation of the reservation and linking of the primary seat and adjacent seat(s).

Preferably, the method includes the step of:
receiving notification of the cutoff date being reached from a remote terminal.

Preferably, the method includes the step of:
receiving a notification of finalization of allocation of the adjacent seat(s) with the primary seats(s) indicating the final allocation of primary seat(s) and adjacent seat(s) to said passenger(s).

In a further aspect the invention may be said to broadly consist in a vehicle tandem seat allocation system comprising
a processor;
a transmitter
a receiver;
at least one computer readable storage means for storing instructions
instructions configured for:
   interrogating a seat bookings database of stored seating information for information relating to the availability of a pair of primary seats in a seating configuration of a vehicle for an event;
   receiving passenger information indicative of a pair of passenger's details;
   storing linking information linking the primary seats with said passenger information to thereby assign said primary seats to said passengers;
   interrogating a seat bookings database of stored seating information for information relating to the availability of at least one adjacent seat adjacent to the primary seats;
   storing linking information linking the adjacent seat(s) to one or more selected from
      said passenger information; and
      said primary seat;
      wherein the said primary seats and said adjacent seat(s) are configurable between three single seats and a horizontal double bed on which two passengers can lay side by side.

Preferably, the primary seats and adjacent seats are reconfigurable by virtue of the fact that each seat includes a seat back, a seat pan and a foot rest, said foot rest moveably mounted relative to the seat pan to allow it to move between a stored condition and a extended condition where the seat pan and the foot rest cooperate to provide substantially horizontal passenger support.

Preferably the instructions are further configured for:
transmitting a first booking signal for changing the indicated availability of the primary seats as being reserved on the seat bookings database;

Preferably the instructions are further configured for:
transmitting a reservation instruction for changing the indicated availability of the adjacent seat as being reserved on a seating reservations database.

Preferably the instructions are further configured for:
interrogating a seating configuration database of stored seating information of a vehicle for an event, to check whether said primary seats and/or said adjacent seat are of a type configurable between three single seats and a horizontal double bed on which two passengers can lay side by side to return an affirmative or negative result.

Preferably the instructions are further configured for, in the event of receiving a negative result from the interrogation, further interrogating the seating configuration database to find a pair of primary seats and/or an adjacent seat.

Preferably the instructions are further configured for:
recommending an alternative set of two primary seats and an adjacent seat.

Preferably, the step of recommending an alternative set of two primary seats and an adjacent seat comprises the step of transmitting a recommendation signal for the display of said recommendation.

Preferably the instructions are further configured for:
receiving an instruction to link said adjacent seat(s) to one or more selected from
   said passenger information; and
   said primary seat.

Preferably the instructions are further configured for:
storing a linking information related to said primary seat(s) and said adjacent seats in a seating reservations database.

In a further aspect the invention may be said to broadly consist in a vehicle seat allocation system comprising
a processor;
a transmitter
a receiver;
at least one computer readable storage means for storing instructions
instructions configured for:
interrogating a seat bookings database of stored seating information for information relating to the availability of a primary seat in a seating configuration of a vehicle
receiving passenger information indicative of a passengers details;
storing linking information linking the primary seat with said passenger information to thereby assign said primary seat to said passenger;
interrogating a seat bookings database of stored seating information for information relating to the availability of at least one or more adjacent seats located directly adjacent to the primary seat;
storing linking information linking the adjacent seat(s) to one or more selected from
   said passenger information; and
   said primary seat;
wherein the said primary seats and said adjacent seat(s) are configurable together to provide a horizontal sleeping surface.

Preferably, the said primary seats and said adjacent seat(s) are configurable between a single seat configuration and a horizontal double bed configuration on which at least two passengers can lay side by side.

Preferably, the system includes a computer readable database storage medium for storing linking information.

Preferably the instructions are further configured for:
transmitting a reservation instruction for changing the indicated availability of a primary seat as being reserved;

Preferably the instructions are further configured for:
receiving an instruction to link the passenger information with a primary seat selected from the stored seating information indicative of a seating configuration;

Preferably the instructions are further configured for:
receiving an instruction to link said adjacent seat(s) to one or more selected from
   said passenger information; and
   said primary seat; and

Preferably the instructions are further configured for:
receiving a first interrogation instruction signal instruction to interrogate the seat bookings database for the availability of a primary seat before interrogating the seat bookings database for the availability of a primary seat;

Preferably the instructions are further configured for:
receiving a second interrogation instruction signal to interrogate the seat bookings database for the availability of an adjacent seat before interrogating the seat bookings database for the availability of the adjacent seat(s);

Preferably the instructions for interrogating a seat bookings database of stored seating information to establish the availability of the primary seat and the adjacent seat(s) are configured for being carried out at the same time.

Preferably the instructions configured for interrogating a seat bookings database of stored seating information for information relating to the availability of one selected from the primary seat and the adjacent seat(s) includes instructions configured for:
transmitting an interrogation signal; and
receiving a reply signal indicative of whether the requested seat is available in the affirmative or negative.

Preferably the instructions configured for interrogating a seat bookings database of stored seating information for information relating to the availability of a seat in a seating configuration of a vehicle, are configured for interrogation of a remote database.

Preferably, the remote database is the Galileo™ database.

Preferably the instructions are further configured for:
storing seating information indicative of a seating configuration in a vehicle in a seat bookings database.

Preferably the instructions are further configured for:
receiving an interrogation signal requesting confirmation of the linking of the adjacent seat(s) to one or more selected from
   said passenger information; and
   said primary seat;

Preferably the instructions configured for storing linking information linking the primary seat with said passenger information to thereby assign said primary seat to said passenger are further configured for storing the passenger information and/or the primary seat information.

Preferably the instructions configured for storing linking information are configured for storing the linking information in a database.

Preferably the instructions configured for storing linking information are configured for storing the linking information in a seating reservations database.

Preferably, the linking information is one or more selected from
passenger details, such as
   name,
   nationality,
   loyalty club membership details;
   disabilities;
   passenger physical features;
information indicative of the adjacent seat number;
payment details; and
whether the passenger is travelling with small children.

Preferably, the payment details of the linking information may include a bid of a monetary value associated with one or more primary seats of a monetary value.

Preferably the instructions are further configured for:
transmitting a confirmation signal confirming the linking of said adjacent seat(s) and said primary seat.

Preferably, the instructions are configured for transmitting a confirmation signal of a protocol that may be printed as evidence of the linking of the primary seat and the at least one adjacent seat.

Preferably the instructions are further configured for:
transmitting a boarding card print signal suitable for allowing the printing of a boarding card indicating that the primary seat and the at least one adjacent seat is linked.

Preferably the instructions are further configured for:
transmitting a reservation confirmation signal to show that the primary seat has been reserved.

Preferably the instructions are further configured for:
transmitting a reservation confirmation signal to show that the adjacent seat(s) have been reserved.

Preferably, the reservation confirmation signal is transmitted to a remote terminal connected to the Internet.

Preferably the instructions are further configured for:
interrogating a seating configuration database of stored seating information of a vehicle for an event, to establish whether said primary seat and/or said adjacent seat (“the proposed seats”) are of a type configurable together to provide a horizontal sleeping surface, to return an affirmative or negative result.

Preferably the instructions configured for interrogation of the seating configuration database are configured for establishing whether said primary seat and/or said adjacent seat are of a type configurable between a single seat configuration and a horizontal double bed configuration.

Preferably the instructions are further configured for, in the event of the return of a negative result from the interrogation to establish whether said primary seat and/or said adjacent seat (“the proposed seats”) are of a type configurable together to provide a horizontal sleeping surface,
recommending that an alternative set of seats of a similar number to the proposed set of seats be found that are of a type configurable between a single seat configuration and a horizontal double bed configuration.

Preferably the instructions are further configured for, in the event of receiving a negative result from the interrogation to establish whether said primary seat and/or said adjacent seat (“the proposed seats”) are of a type configurable together to provide a horizontal sleeping surface,
further interrogating the seating configuration database for an alternative set of seats of a similar number which are of a type configurable together to provide a horizontal sleeping surface to return an affirmative or negative result.

Preferably the instructions are further configured for, in the event that an affirmative result is returned from the interrogation of the seating configuration database for an alternative set of seats of a similar number which are of a type configurable together to provide a horizontal sleeping surface,
calculating a preferred alternative set of seats.

Preferably the instructions are further configured for calculating an alternative set of seats of a similar number in said vehicle so as to optimize one or more of:
passenger comfort;
passenger personal space;
commercial effect or viability.

Preferably the instructions are further configured for: recommending an alternative set of seats, of a similar number, to the proposed seats.

Preferably the instructions configured for recommending an alternative set of seats of a similar number are further configured for transmitting a recommendation signal for the display of said recommendation.

Preferably the instructions configured for calculating an alternative set of seats are configured to carried out the calculations in accordance with an algorithm for the maximization of the number of available primary seats with unallocated seats around them that are available for use as adjacent seats.

Preferably the instructions are further configured for:
transmitting information indicative of a recommended adjacent seat for display.

Preferably the instructions are further configured for, in the event that a negative result is returned from the interrogation of the seating configuration database for an alternative set of seats of a similar number which are of a type configurable together to provide a horizontal sleeping surface,
comparing at least part of the linking information of the proposed seats with the linking information of a previously allocated set of primary and adjacent seats of a similar number.

Preferably, the linking information that may be compared is
passenger payment details;
whether passenger has already paid for the adjacent seat;
whether the passenger is a member of a loyalty program;
whether the passenger is travelling with children;
whether the passenger is listed as a being disabled or sick;
whether the adjacent seat was the last adjacent seat allocated.

Preferably the instructions configured for comparison of the payment details of the linking information are further configured for comparing a bid associated with one or more primary seats of a monetary value.

Preferably the instructions are further configured for disallowing or allowing the cancelling of one or more of the linking information being compared in accordance with the result of the comparison.

Preferably the instructions are further configured for:
comparing the current date and time with an assigned cutoff date and time;
preventing reallocation of the adjacent seats from the assigned cutoff date and time so that the adjacent seats cannot be reallocated as primary seats.

Preferably the instructions are further configured for generating an assigned cutoff date and time is automatically.

Alternatively, the instructions are further configured for generating an assigned cutoff date and time by reference to an event date and time.

Preferably, the event date and time is a flight.

Alternatively, the instructions are further configured for accepting an assigned cutoff date and time generated by a user.

Preferably the instructions are further configured for:
transmitting notification of the cutoff date being reached to a remote terminal.

According to a further aspect, the invention may be said to broadly consist in vehicle seat reservation system comprising
a processor;
a transmitter;
a receiver;
at least one computer readable storage means for storing instructions
downloadable instructions configured for:
   transmitting an first interrogation instruction signal for interrogating a remote seat bookings database of stored seating information for the availability of a primary seat in a seating configuration of a vehicle for an event;
   receiving a signal confirming the availability of the primary seat;
   transmitting a booking signal instructing the reservation of the primary seat to thereby render it unavailable to others;
   transmitting passenger information indicative of a passenger's details;
   transmitting a second interrogation instruction signal for interrogating a remote seat bookings database of stored seating information for the availability of one or more adjacent seats in a seating configuration of a vehicle for an event,
   transmitting passenger information to a remote terminal;
   transmitting a linking storage signal instructing the remote storage of linking information linking the adjacent seat(s) to one or more selected from
      said passenger information; and
      said primary seat;
   wherein said primary seat and said adjacent seats are configurable to together provide a horizontal sleeping surface.

Preferably, the instructions are configured for reserving at least two primary seats and one adjacent seat, wherein primary seats and adjacent seat(s) are configurable between a single seat configuration and a horizontal double bed configuration on which at least two passengers can lay side by side.

Preferably the instructions are further configured for:
receiving a signal confirming the availability of the adjacent seat(s);

Preferably the instructions are further configured for:
transmitting a booking signal instructing the reservation of the adjacent seat(s) to thereby render it unavailable to others;

Preferably the instructions are further configured for:
transmitting a linking storage signal instructing the remote storage of linking information linking the adjacent seat(s) to said primary seat.

Preferably, the linking information is one or more selected from
passenger details, such as
   name,
   nationality,
   loyalty club membership details;
   disabilities;
   passenger physical features;
information indicative of the adjacent seat number;
payment details; and
whether the passenger is travelling with small children.

Preferably, the payment details of the linking information may include a bid of a monetary value.

Preferably the instructions configured for sending the booking signal instructing the reservation of the adjacent seat(s) simultaneously with the linking storage signal.

Preferably the instructions are further configured for:
receiving a reservation confirmation signal confirming the reservation of the primary seat and adjacent seat(s)

Preferably the instructions are further configured for:
transmitting a print signal for printing confirmation of the reservation and linking of the primary seat and adjacent seat(s).

Preferably the instructions are further configured for:
receiving notification of the cutoff date being reached from a remote terminal.

Preferably the instructions are further configured for:
receiving a notification of finalization of allocation of the adjacent seat(s) with the primary seats(s) indicating the final allocation of primary seat(s) and adjacent seat(s) to said passenger(s).

In a further aspect the invention may be said to broadly consist in a vehicle seat allocation system comprising
a processor
a transmitter
a receiver;
at least one computer readable storage means for storing instructions
instructions configured for:
   interrogating a seat bookings database of stored seating information for information relating to the availability of a pair of primary seats in a seating configuration of a vehicle for an event;
   receiving passenger information indicative of a pair of passenger's details;
   storing linking information linking the primary seats with said passenger information to thereby assign said primary seats to said passengers;
   interrogating a seat bookings database of stored seating information for information relating to the availability of at least one adjacent seat adjacent to the primary seats;
   storing linking information linking the adjacent seat(s) to one or more selected from
      said passenger information; and
      said primary seat;
   wherein the linking information linking the adjacent seat(s) to one or more selected from said passenger information; and said primary seat, is a bid indicative of a monetary value.

Preferably, the instructions are configured for comparing the monetary value of a bid of stored linking information of a passenger against the monetary value of a bid of stored linking information of a passenger.

Preferably, the instructions are configured for finalizing allocation of an adjacent seat to a passenger according to the results of the comparison.

According to a further aspect, the invention may be said to broadly consist in a computer readable storage medium having thereon program code for executing the steps of any of the methods described above.

According to a further aspect, the invention may be said to broadly consist in a seat allocation system comprising a computer system having components for executing the steps of any one of the methods described above.

According to a further aspect, the invention may be said to broadly consist in a seat reservation system comprising a computer system having components for executing the steps of any one of the methods described above.

According to a further aspect, the invention may be said to broadly consist in a seat allocation method substantially as described herein with or without reference to the accompanying figures.

According to a further aspect, the invention may be said to broadly consist in a seat allocation system substantially as described herein with or without reference to the accompanying figures.

According to a further aspect, the invention may be said to broadly consist in a seat reservation method substantially as described herein with or without reference to the accompanying figures.

According to a further aspect, the invention may be said to broadly consist in a seat reservation system substantially as described herein with or without reference to the accompanying figures.

According to a further aspect, the invention may be said to broadly consist in a method of selling passenger space onboard an aircraft comprising:
offering an upgrade to at least one passenger from a single seat booking or reservation in a particular class of the aircraft, to a seating arrangement that will allow the passenger to assume a sedentary position, a lounging style position and a fully reclined position in that same class.

Preferably the offering occurs at or prior to check-in or boarding for the flight.

Preferably the upgrade is offered to two companion passengers that can both assume a sedentary position, a lounging style position and a fully reclined position utilising the seating arrangement.

Preferably the seating arrangement is a row of at least 3 adjacent seats that each include a seat pan and a leg rest, the leg rest able to move between a stored position adjacent and extending downwardly from the front edge of the seat pan and a horizontal position wherein it provides a resting surface that is coplanar with the upper surface of the seat pan.

The seating arrangement allows said two passengers to lie flat in a side by side position.

Preferably that is perpendicular to the longitudinal direction of the body of the aircraft.

According to a further aspect, the invention may be said to broadly consist in a method of selling space onboard an aircraft comprising:
offering an upgrade to at least two companion passenger from a single seat booking or reservation, to a seating arrangement that will allow the passengers to assume a sedentary position, a lounging style position and a fully reclined position, the seating arrangement is a row of at least 3 adjacent seats that each include a seat pan and a leg rest, the legrest able to move from a stored position adjacent and extending downwardly from the front edge of the seat pan to a horizontal position wherein it provides a resting surface that is coplanar with the upper surface of the seat pan.

Preferably the offering occurs at or prior to check-in or boarding for the flight.

As used herein the term “and/or” means “and” or “or”, or both.

As used herein “(s)” following a noun means the plural and/or singular forms of the noun.

The term “comprising” or “including” as used in this specification [and claims] means “consisting at least in part of”. When interpreting statements in this specification [and claims] which include that term, the features, prefaced by that term in each statement, all need to be present but other features can also be present. Related terms such as “comprise” and “comprised” and “include” and “included” are to be interpreted in the same manner.

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

Other aspects of the invention may become apparent from the following description which is given by way of example only and with reference to the accompanying drawings.

### BRIEF DESCRIPTION OF DRAWINGS

Preferred embodiments of the present invention are shown in the accompanying drawings in which;

FIG. 1 shows a front perspective view of a seating arrangement with individual seats positioned in various configurations;

FIG. 2 shows a back perspective view of a seating arrangement of FIG. 1 with individual seats positioned in various configurations;

FIG. 3 shows a top view of a seating arrangement of FIG. 1;

FIG. 4 shows a side view of a seating arrangement of FIG. 1;

FIG. 5 shows a side view of the seat pan arrangement, foot rest arrangement and articulated coupling of a seat arrangement in a stowed condition;

FIG. 6 shows a side view of the seat pan arrangement, foot rest arrangement and articulated coupling of a seat arrangement in a partially extended position;

FIG. 7 shows a side view of the seat pan arrangement, foot rest arrangement and articulated coupling of a seat arrangement in a fully extended position;

FIGS. 8-28 shows schematic plan views of seating arrangements in various configurations, including typical arrangements of passengers for their configurations, illustrating the flexibility of the seat arrangement;

FIG. 29 shows a top perspective view of a plurality of tray tables in a first configuration;

FIG. 30 shows a top perspective view of a plurality of tray tables in a second configuration;

FIG. 31 shows a schematic plan view of an aircraft including a plurality of seat units in two columns of three seat units abreast; and

FIG. 32 shows a schematic plan view of an aircraft including a plurality of seat units in two columns of three seat units abreast, with an intermediate column of four seat units abreast.

FIG. 33 shows a schematic drawing of a vehicle seat reservation system and vehicle seat allocation system;

FIG. 34 shows a schematic layout indicating actions taken from varying aspects of a first part of a method of allocating vehicle seating and method of reserving vehicle seating.

FIG. 35 shows a schematic layout indicating actions taken by from varying aspects of a second part of the method of allocating vehicle seating and method of reserving vehicle seating.

FIG. 36 shows a schematic flow diagram showing a part of a method of reserving vehicle seating;

FIG. 37 shows a schematic flow diagram showing a part of a method of reserving vehicle tandem seating;

FIG. 38 shows a schematic flow diagram showing a part of a method of reserving vehicle seating showing optimisation of seating allocation;

FIG. 39 shows a schematic flow diagram showing a part of a method of reserving vehicle seating;

FIG. 40 shows a schematic diagram of a booking system;

FIG. 41 shows a flow diagram for booking a multi-person space.

FIG. 42 shows a flow diagram of a pricing method.

FIGS. 43a, 43b shows possible seating configurations.

### DETAILED DESCRIPTION OF PREFERRED EMBODIMENTS

### Overview

The present invention generally relates to methods and systems for allocating seats on an aircraft in relation to a flight reservation for passengers on that aircraft. More particularly, it relates to allocating seats in “couch-style” seating spaces (hereinafter: multi-person seating spaces), being a group of two or more contiguous seats in an aircraft that are arranged, configured, configurable and/or adapted such that in addition to the usual practice of a passenger sitting in an allocated seat and only that seat, the multi-person seating space can be utilised in a range of other ways, such as for lying or lounging on by one or more passengers.

The multi-person seating space could be, for example, three guaranteed adjacent seats for a journey. The adjacent seats form a contiguous multi-person space, suitable for accommodating a plurality of passengers. For example, the multi-person seating space can comprise adjacent seat pans that are touching or close to each other. Alternatively, the multi-person space could be a single physical unit, rather than independent seats, that provides the equivalent space of three adjacent seats for passengers. That is, there would still be three seats/seat pans, but formed as an integrated unit. Either way, the space can be considered and reserved as a single unit, as it can be configured as such, but it has multiple seats/seat pans within that unit (usually three or more). Each seat or seat pan (whether separate or integrated) forms a passenger location which a passenger can occupy during a flight. Reference to the term “seat” can refer to a passenger location in any configuration mentioned above.

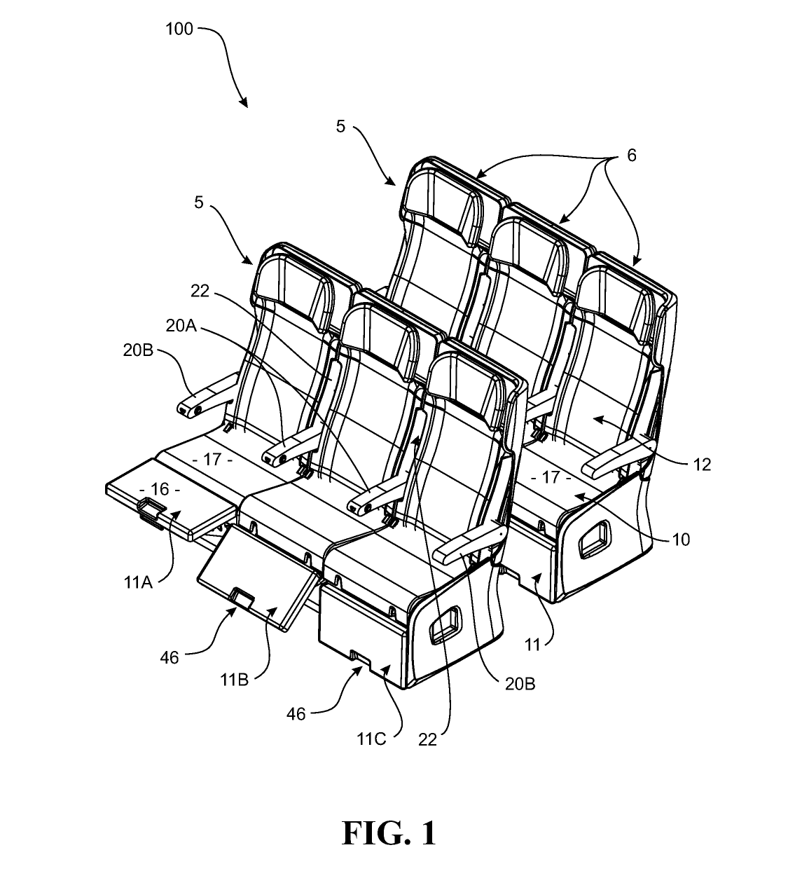

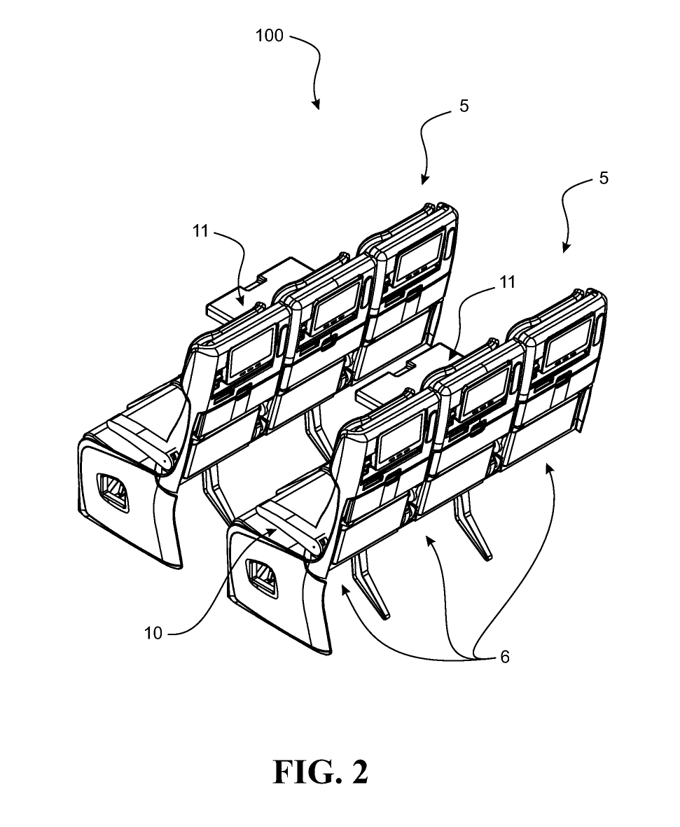

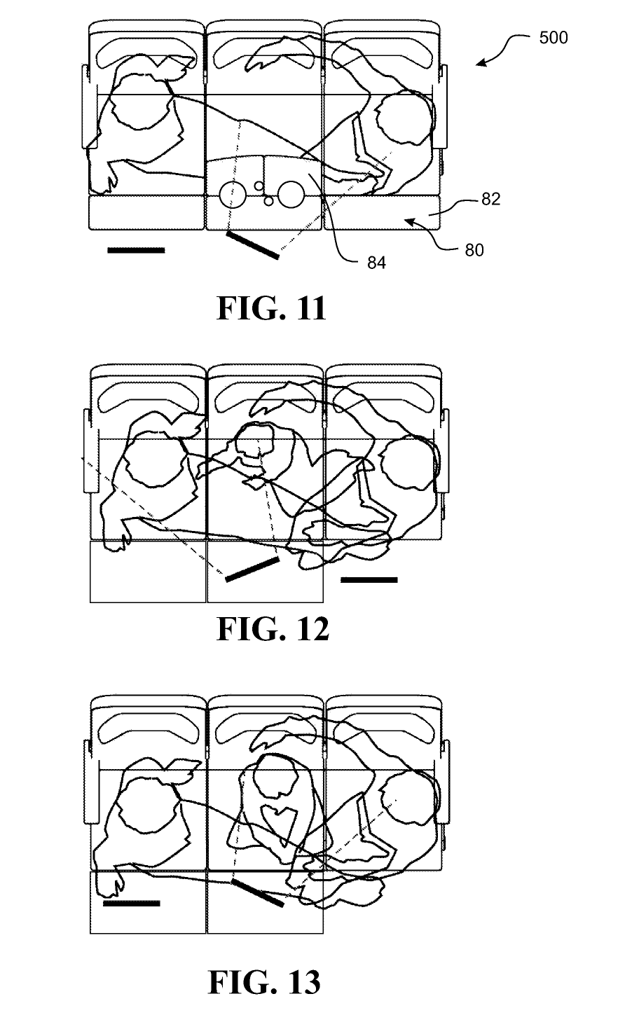

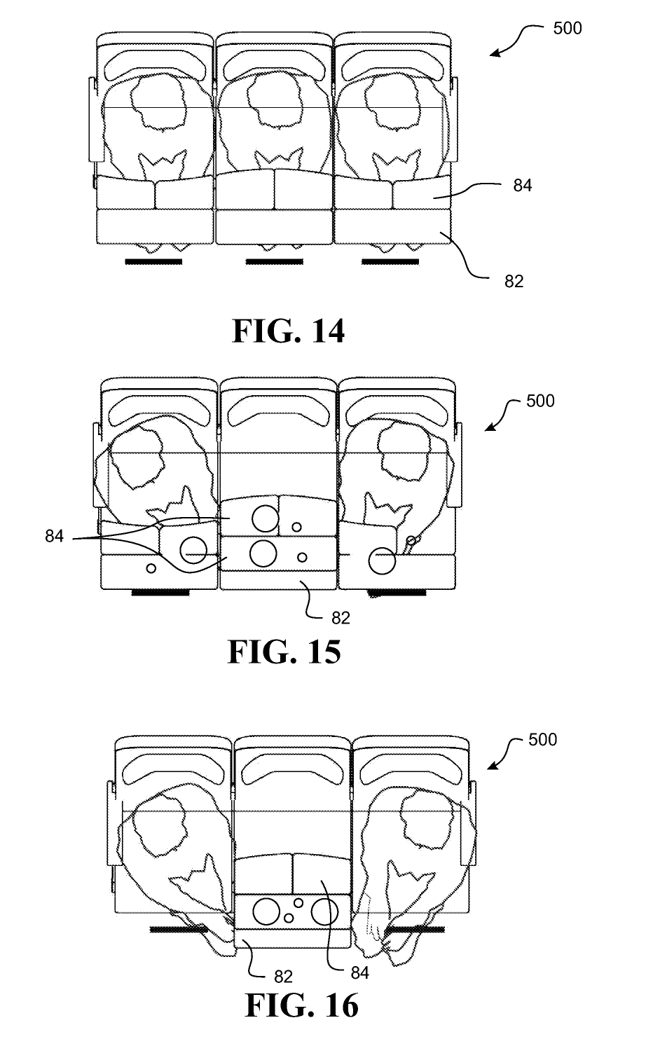

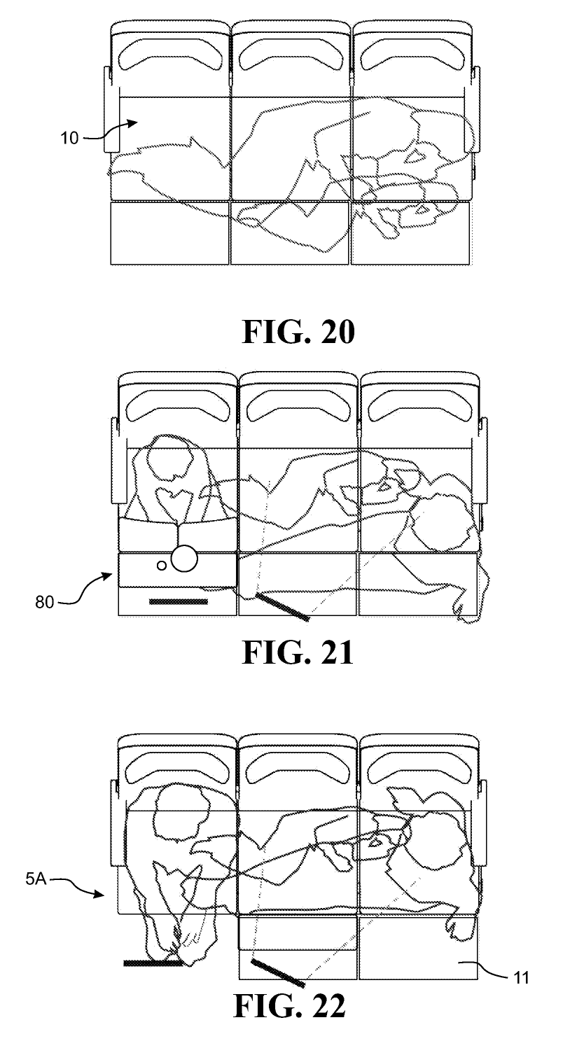

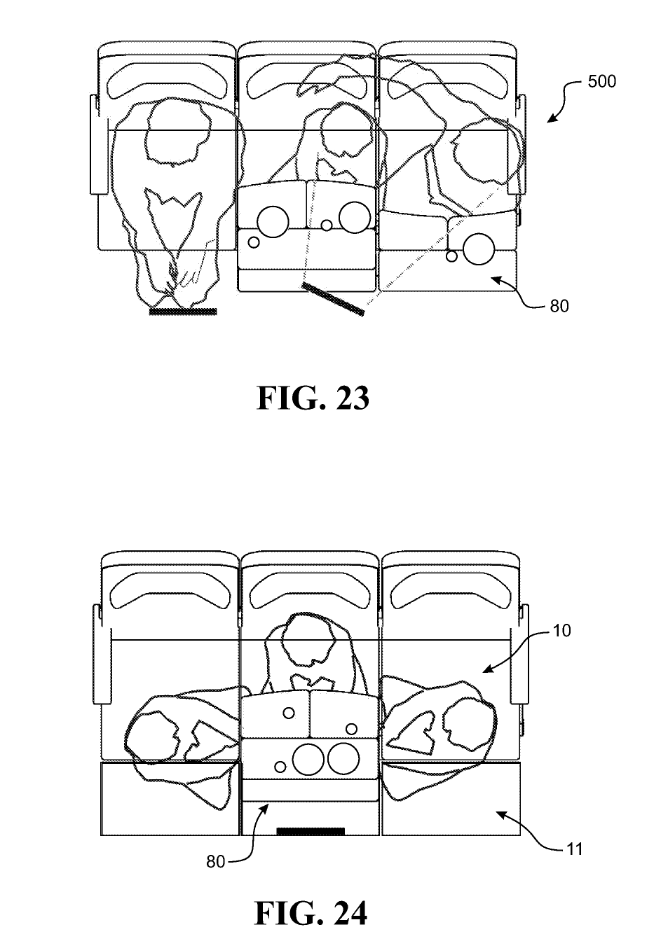

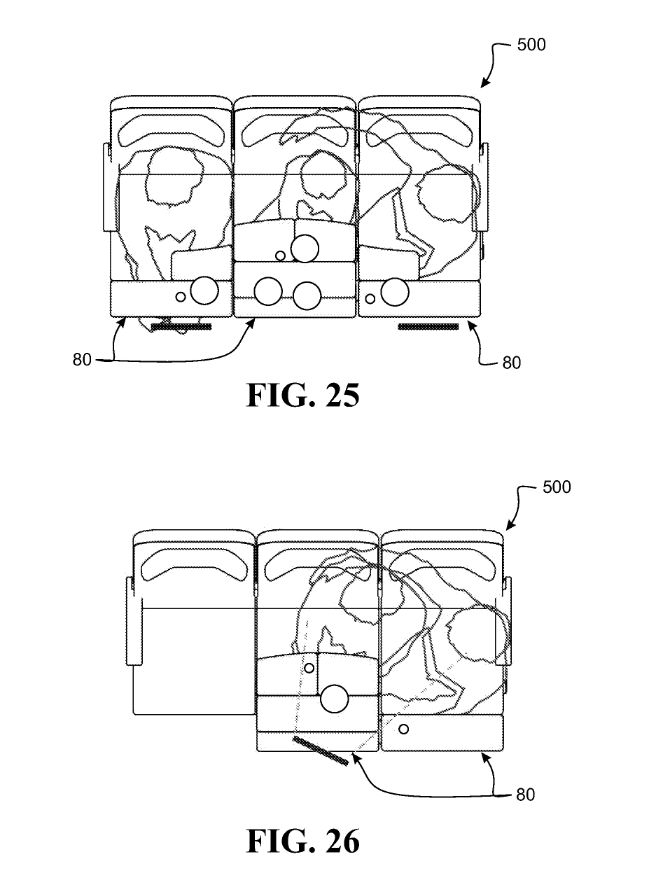

The multi-person seating space can comprise any two or more contiguous seats (either separate or integrated) that a passenger can lie across the seat pans substantially unimpeded (for example without interference from armrests, significant gaps or other physical interferences). The multi-person seating space could comprise or be made up of standard aircraft seats, or alternatively the seats such as shown in FIGS. 1 to 28 and as described below with reference to them, although this is not essential. An aircraft can have a plurality of multi-person seating spaces, each comprising a plurality of seats. Each multi-person seating space can therefore be the nominal setting aside of contiguous standard (e.g. economy class) aircraft seats in a plane for use as a multi-person seating space, or can be special seats physically configured or configurable into such a multi-person seating space. For example, in the case of the multi-person seating space made up of seats such as shown in FIGS. 1 to 28, the space comprises seat pans that can be configured with one or more extension surfaces such as leg rests that extend substantially co-planar with each seat pan, which in combination with the seat pans, provide additional support surface for passengers—such as additional space on which to lie down or lounge upon. The aircraft could also have a plurality of standard seats that are not nominally set aside as multi-person seating spaces, but rather set aside for individual allocation.

Associated passengers for a reservation request for a flight can request reservation of one or more multi-person seating spaces. Any number of passengers up to the number of passenger locations in the multi-person seating space can be allocated to a multi-person seating space. The multi-person seating space provides the ability for those passengers allocated to it to configure and use the space how they prefer, for seating and/or sleeping throughout the journey. If the standard seating spaces are all allocated, the seats nominally set aside or specially configured as a multi-person seating space can be re-nominated for individual allocation.

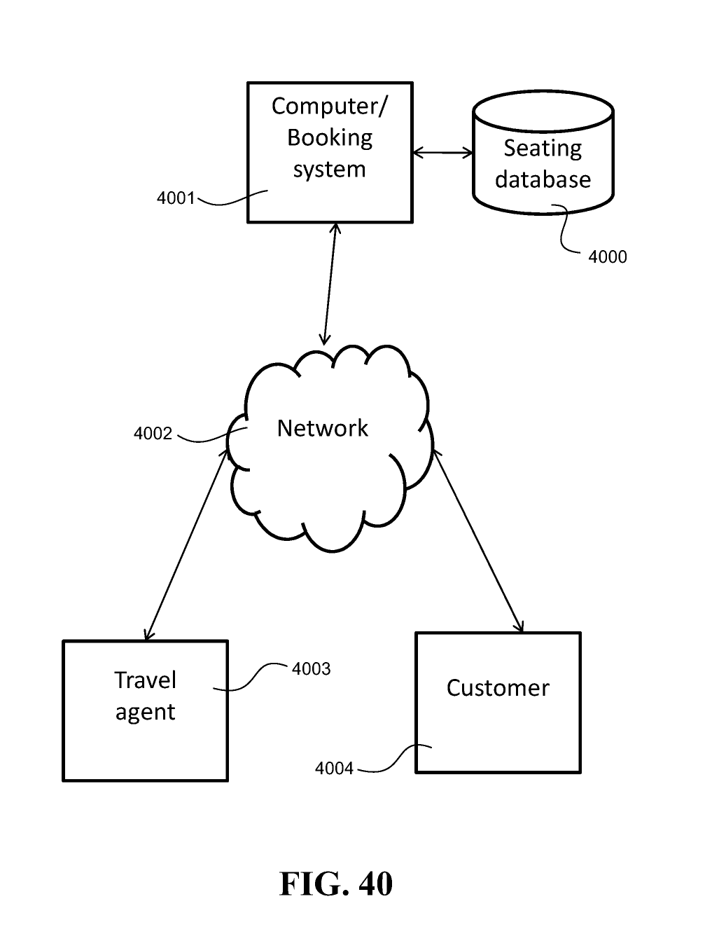

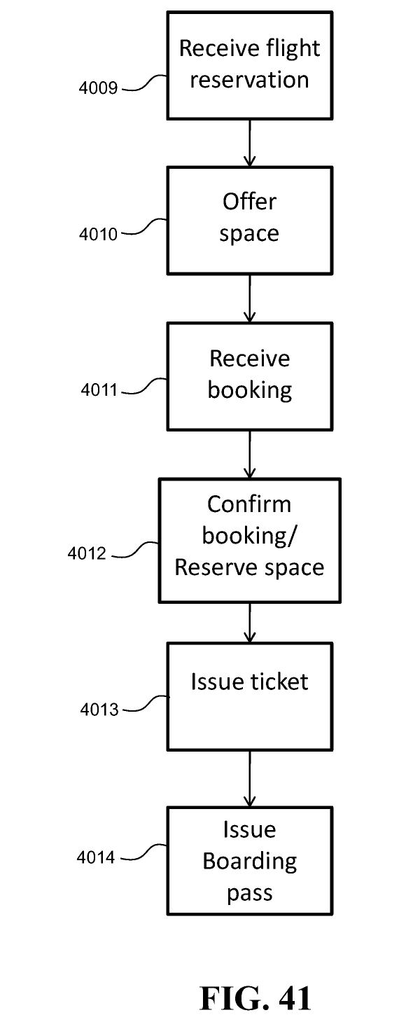

An overview of the method and system for allocating the multi-person seating spaces will be briefly described with respect to FIGS. 40 and 41. Various alternative embodiments will be described in detail below. Referring to FIGS. 40 and 41, a computer booking system 4001 receives requests, step 4009, via the internet 4002, for reservations for flights on an aircraft, each reservation request coming from a travel agent 4003 or customer direct 4004. The reservation request relates to one or more passengers, each being associated passengers which together form a booking party. At that point, or later, the airline can optionally offer an upgrade, step 4010 at which point the customer can request that the booking party be allocated to one or more multi-person seating spaces (optionally in combination with regular seats). Alternatively, the option can be available for request by a customer, without it being specifically offered to them. Therefore, the term “offer” in this context can be interpreted broadly to mean “made available for reservation”. The computer system 4001 receives the request for the multi-person space(s), step 4011. It checks the required seats are available, then confirms and reserves the necessary seats in the multi-person seating space, step 4012. It does this by allocating one or more of the associated passenger in the party to a seat in one of the available multi-person spaces (others in the party might be allocated to regular seats). As a result, the multi-person seating space is also nominally assigned or allocated to the associated passengers allocated to it, although this might not be represented in the booking system as such.

A flight for an aircraft has an inventory of seats in a database 4000, which keeps track of the number of seats available for allocation for that particular flight. If the request for a multi-person seating space(s) is related to a party with fewer passengers than the number of passenger locations in the multi-person seating space(s), there will be spare seats. Those seats will not be allocated to a passenger and would appear unoccupied/unreserved in a traditional booking system. However, the spare passenger locations are for the use of the passengers in the multi-person seating space and should not be allocated to other passengers. To avoid this, if the number of associated passengers for a request is less than the number of seats in the multi-person seating space, then the total number of seats in the seat inventory is reduced by the number of spare seats. This prevents the spare seats being allocated to other passengers, without the need for actually allocating the spare seat to a particular passenger. For all intents and purposes, the inventory of seats for the flight appears to be less than the actual number of passenger locations/seats on the flight—the difference being the spare seats.

The request for multi-person seating spaces and the allocation of the seats takes place at or near the time of booking, or later any time prior to check-in. The request for a multi-person seating space can occur in the window between request a flight reservation and check-in. The multi-person seating system can become and entitlement that is added to the booking.

A ticket is the generated, step 4013 by the computer system. This identifies the passengers for the reservation and optionally the multi-person seating space and/or optionally the actual allocated seats. Upon check-in, a boarding pass is issued for each passenger identifying their allocated seat, and optionally the multi-person seating space nominally allocated to them. As part of that check-in process, the party might be able to choose which multi-person seating space(s) they use

Particular embodiments of the invention will now be described.

Seating

The multi-person seating space might comprise seats configured or configurable as follows. With reference to the above drawings, in which similar features are generally indicated by similar numerals, a seating arrangement according to a first aspect of the invention is generally indicated by the numeral 100.

With reference to FIG. 1 there is shown a seating arrangement 100 that may be carried on board a commercial aircraft 300. The seating arrangement 100 consists of at least two rows 5 of seats 6 that are positioned one behind the other. Each row of seats 5 includes at least 3 adjacent seats 6. Each seat 6 in a row 5 includes a seat back 12, seat pan arrangement 10 and preferably also a foot rest arrangement 11. Each seat 6 can receive a passenger in a sedentary position. Each row preferably faces in a forward direction in relation to the body of the aircraft. In other words, the seat back 12 faces toward the front of the aircraft. The seats in a row are in close juxtaposition. The seats may be individual seat units or parts of it may be provided in a unitary manner. Each row 5 may also be an assembly of components to create a row as a unit.

Preferably each row has at least two seats, more preferably at least three seats and most preferably only three seats.

Where a seat includes a foot rest arrangement 11, the position of the foot rest arrangement can be independently controlled relative to the other foot rest arrangements of the other seats 6 in each row 5. Accordingly a passenger sitting in an individual seat can select a desired foot rest arrangement position.

With reference to the forward most row 5 of seat 6 shown in FIG. 1, each seat 6 in that row shows its respective foot rest arrangement in a different position. Foot rest arrangement 11a is shown in a fully extended position, foot rest arrangement 11b is shown in a partially extended position and foot rest arrangement 11c is shown in a stored position.

The foot rest arrangement 11 of each seat remains in close proximity to the seat pan arrangement 10. This close proximity ensures that substantially no gap is created between the supporting surface 16 of each foot rest arrangement and the supporting surface 17 of the respective seat pan arrangement of a seat arrangement 6 at least when the foot rest arrangement is in the fully extended position. In the fully extended position as shown with reference to foot rest arrangement 11a, the supporting surface 16 cooperates with the respective seat pan arrangement to define a sleeping or resting surface. It is preferably substantially coplanar and defined at least by the supporting surface 16 and the seat pan arrangement supporting surface 17. In the preferred form this coplanar arrangement also is substantially horizontal.

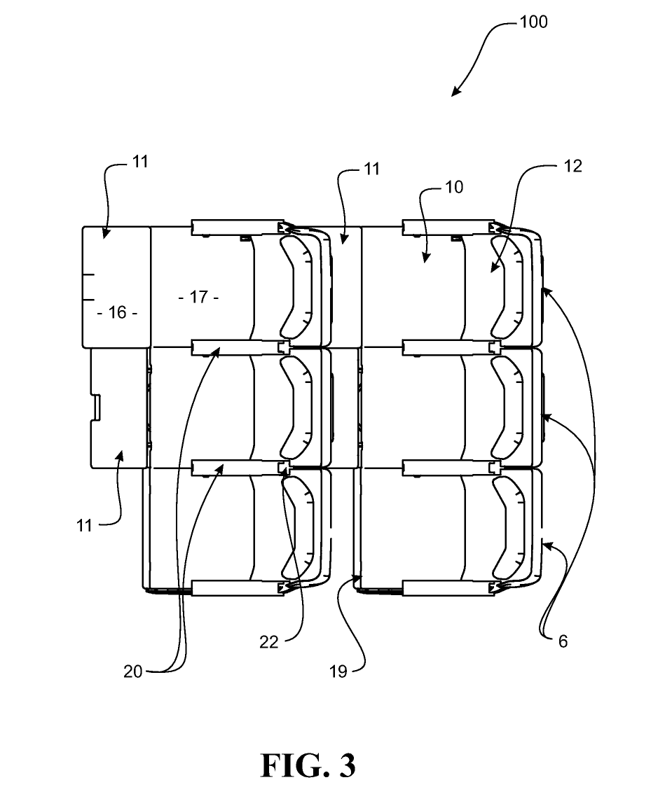

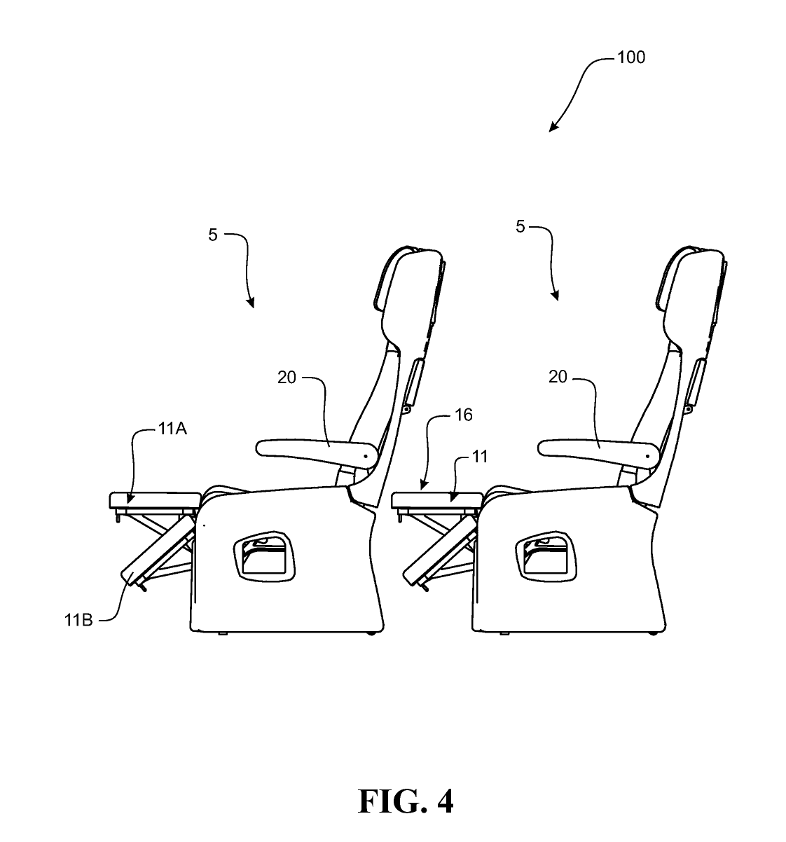

With reference to FIGS. 3 and 4 it can be seen that the supporting surface 16 of a foot rest arrangement 11 may in its fully extended position also extend a substantial distance between the leading edge 19 of the seat pan arrangement, and a seat 6 (such as its back rest) of a row in front of the leading edge 19. A seat arrangement which can facilitate the movement and positioning, including the locking of the foot rest arrangement in various positions from its fully extended position to its stored position, will hereinafter be described.

By providing an independent foot rest arrangement 11 for each seat 6 in a row, each passenger in that row can make a decision about the desired foot rest arrangement position of the seat 6 that that passenger is sitting in.

The provision of independent foot rest arrangements in a row 5 can allow for the position of foot rest arrangements of each row to be positioned in a cooperative manner. For example, with reference to FIG. 18, row 5a has had the foot rest arrangements of each seat unit moved to a fully extended position. This allows for the creation of a sleeping surface that one or more passengers can utilise. As can be seen a passenger in row 5a can lie in a general direction lateral to the forward/aft direction of the aircraft. The arm rests 20 may be movable so as to be moved to a position to not interfere with the passenger lying in this way. For example the arm rests 20a may be moved to a stowed position where they extend substantially vertically and/or may be recessed within and between the back rests of adjacent seats 6 in that row. The outer most arm rests 20b may or may not be movable. However, they may be movable in a like manner to the arm rests 20a.

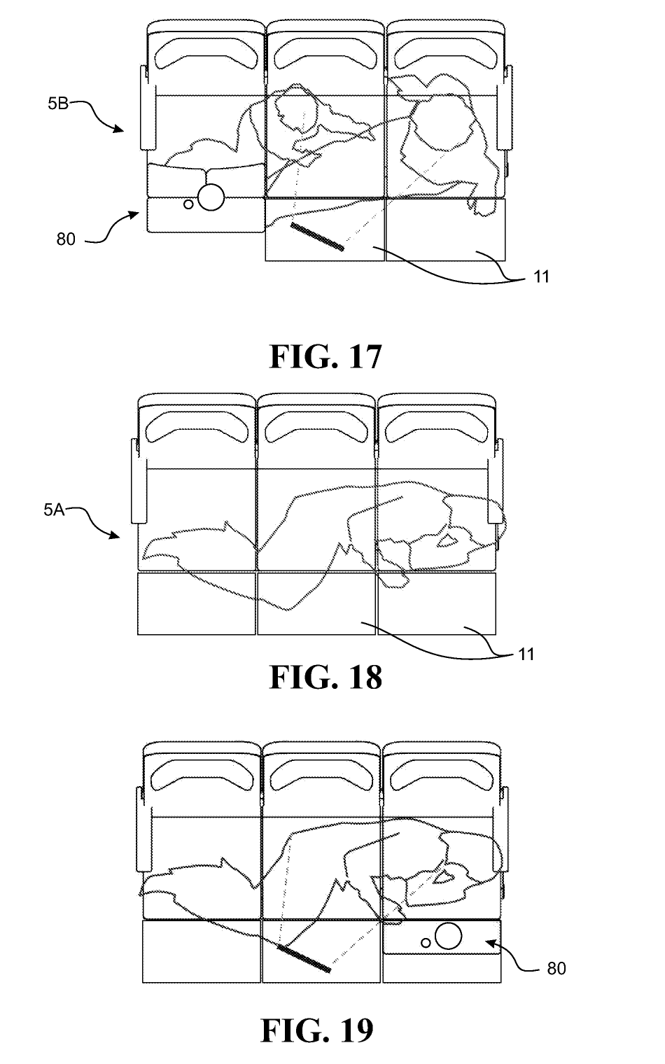

In the configuration where all foot rest arrangements in the row of seat arrangements are extended a single passenger may lie or recline more on the sleeping or resting surface so defined. Multiple passengers such as an adult and a child may be able to share such a sleeping or resting surface. A child may also use the surface of part of the surface as a play area. The surface may also offer support to a person preferring to sit in an upright position but with their legs extending substantially horizontally as for example as shown in row 5b in FIG. 17.

It can be seen that in a partially reclined position of a person a sleeping or resting surface defined by two adjacent seat pan arrangements and foot rest arrangements may be sufficient thereby allowing for a seat at an end of the row to have its foot rest arrangement in a non-fully extended position such as in a partially extended or stored position as shown with respect to row 5b of FIG. 17. This is also shown with reference to row 5a shown in FIG. 22. Likewise other seats in the row may have their foot rest arrangement in a non-fully extended position.

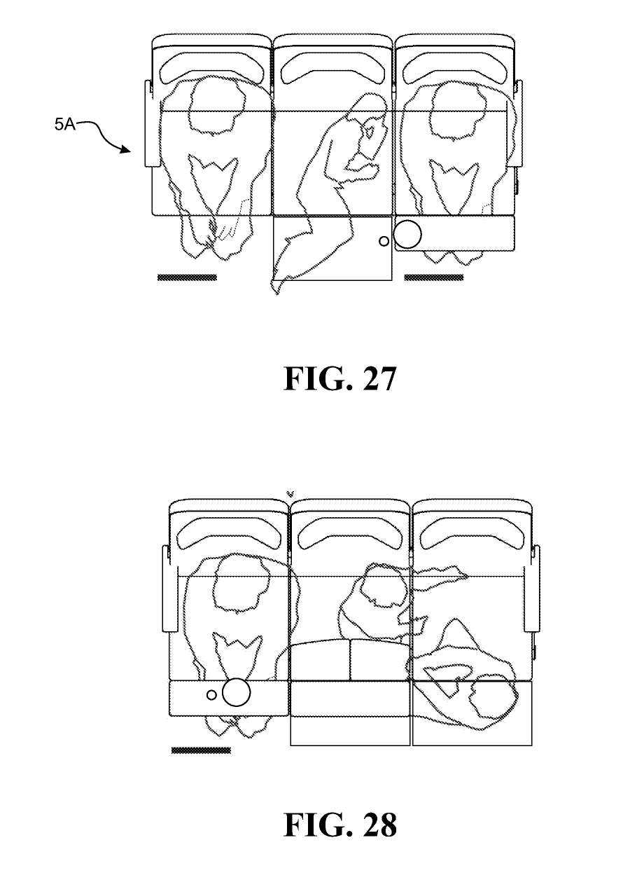

With reference to FIG. 27, various combinations of foot rest arrangement positions of the foot rest arrangements 11 in a row can be achieved. For example with reference to row 5a shown in FIG. 27, seats 6 at the end of a row 5 may have their foot rest arrangements 11 in a stored position whereas the foot rest arrangement 11 of the intermediate seat(s) 6 may be fully extended. In a fully extended position a passenger in the intermediate seat arrangement may be able to sit up with their legs extending substantially horizontally. Alternatively where the person is of a smaller size, the person may be able to lie down. This may be particularly beneficial for adult passengers travelling with babies or small children and can allow for babies or small children to rest more comfortably.

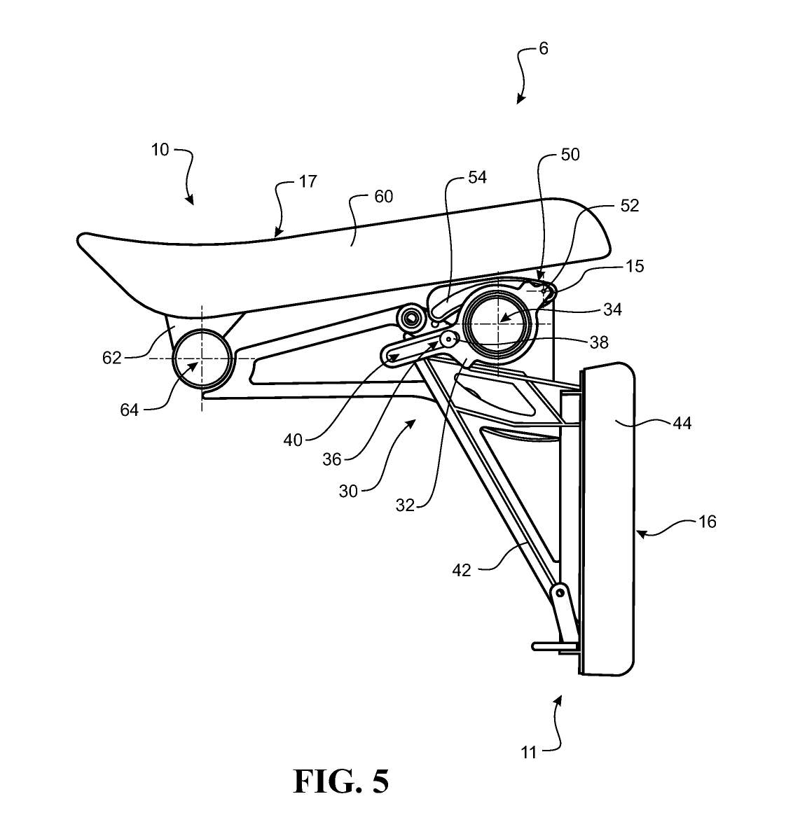

Referring now to FIGS. 5-7, each seat arrangement 200 comprises a seat back 12; a seat pan arrangement 10; a foot rest arrangement 11 and an articulated coupling.

The seat back 12 is configured to be independently moveable between a more upright position and a more reclined position.

The seat pan arrangement 10 includes a seat pan cushion 60 supported at least in part by a seat pan frame 62, and defines a supporting surface 17. The seat pan frame 62 is pivotally mounted to a fixed structural member (not shown) relative the aircraft about a seat pan pivoting axis 64.

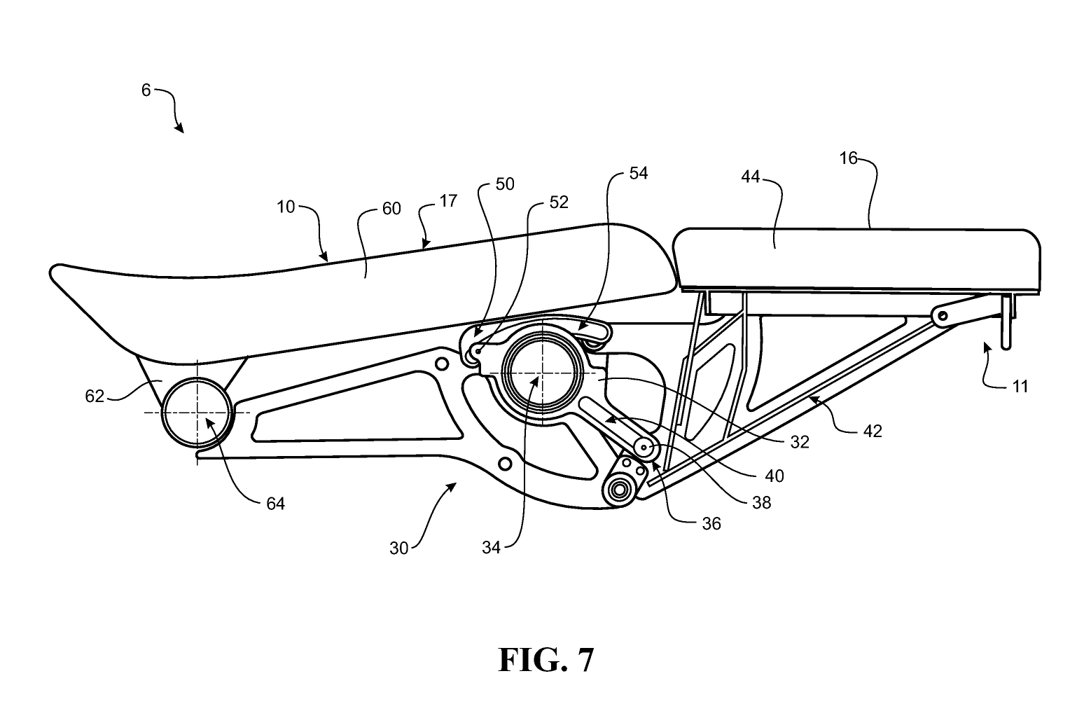

The seat pan arrangement 10 is configured to be moveable between a substantially horizontal position (as shown in FIGS. 5 and 7), and a reclined position in which the seat pan arrangement slopes upwardly towards the front of the seat pan arrangement 10. It is also envisaged that in alternative embodiments, the seat pan arrangement could also move to an inclined position in which the seat pan arrangement slopes downwardly towards the front of the seat pan arrangement 10.

The foot rest arrangement 11 is substantially planar in a preferred embodiment, but it is envisaged that it could include formations or contouring on it. The foot rest arrangement 11 includes a foot rest frame 42 and a foot rest cushion 44 defining a supporting surface 16.

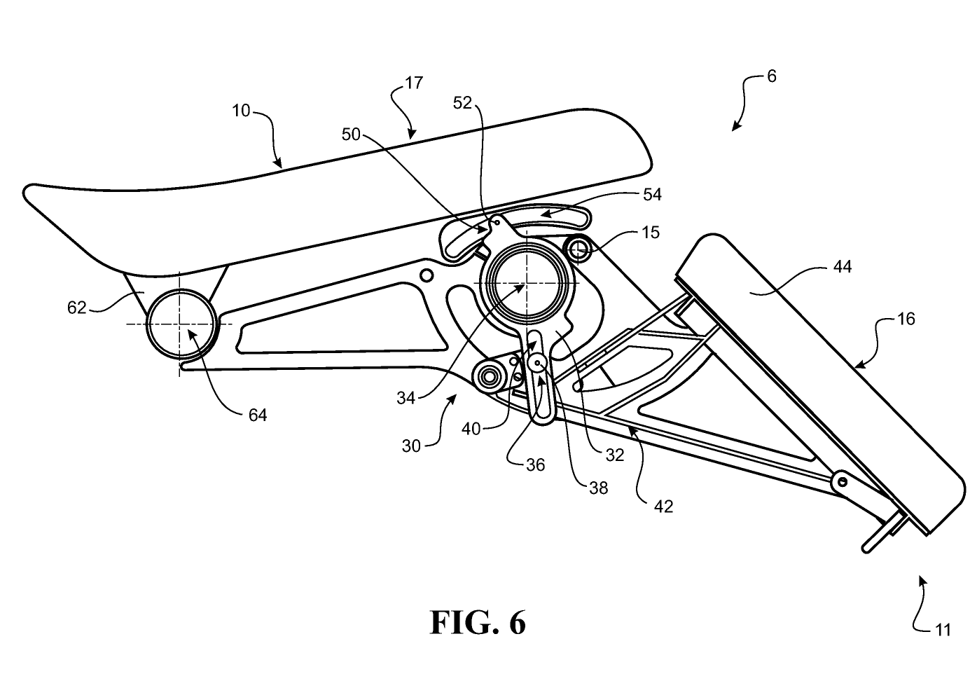

The foot rest arrangement 11 is articulated to pivot about a foot rest pivot axis 15 to be movable between a stored position (as shown in FIG. 5) and a fully extended position (as shown in FIG. 7), and passing through a partially extended position (as shown in FIG. 6). In the stored position, the foot rest arrangement 11 is stowed at least partially beneath the seat pan arrangement 10. In the fully extended position, the foot rest arrangement 11 extends substantially outwardly from the seat pan arrangement 10 to sit co-planar with the seat pan arrangement 10. In the partially extended position, it is envisaged that the plane of the foot rest arrangement 11 will be aligned in a range of between 30 and 60 degree to the vertical, and most preferably at about 45 degrees to the vertical.

The foot rest arrangement 11 and the seat pan arrangement 10 are coupled to each other via an articulated coupling 30. As will be explained in greater detail below, movement of at least one of the seat pan arrangement 10 or the foot rest arrangement 11 causes or can cause movement of the other of the seat pan arrangement 10 and the foot rest arrangement 11.

The articulated coupling 30 includes a coupling pivoting member 32, which is pivotable about a horizontal pivot axis 34. The coupling pivoting member 32 is coupled to the foot rest arrangement by a first sliding mechanism 36. The first sliding mechanism 36 includes a first lug 38 which is slidingly received into and is reciprocatingly movable along a complementary first slot formation 40.

In a preferred embodiment, the first lug 38 extends from the foot rest frame 42, and is received into the first slot formation 40 in the coupling pivoting member 32. However, it is envisaged that other alternative mechanisms may be utilised to drive angular movement of the foot rest arrangement 11 about the foot rest pivot axis 15. In one embodiment, the foot rest pivot axis 15 and the coupling pivot axis 34 of the coupling pivoting member 32 may be coaxial. In yet another embodiment, the coupling pivoting member 32 may be joined with the foot rest arrangement 11.

As shown in FIGS. 5-7, pivoting movement of the foot rest arrangement 11 about the foot rest pivot axis 15 causes pivoting movement of the coupling pivoting member 32 about the coupling pivot axis 34. Since the foot rest pivot axis 15 and the coupling pivot axis 34 are not coaxial in FIGS. 5-7, the first lug 38 will slide within in the first slot formation 40.

The coupling pivoting member 32 is further coupled to the seat pan arrangement 10 by a second sliding mechanism 50. The second sliding mechanism 50 includes a second lug 52 which extends from the coupling pivoting member 32, and is configured and dimensioned to be received into and slidingly move along a complementary second slot formation 54 in the seat pan frame 62. In this way, pivoting movement of the coupling pivoting member 32 about the coupling pivot axis 34 causes sliding movement of the second lug 52 in the second slot formation 54.

Further, sliding movement of the second lug 52 in the second slot formation 54 causes pivoting movement of the seat pan arrangement 10 about the seat pan pivoting axis 64, since the lug 52 acts as a cam follower and the second slot formation 54 acts as a cam. It is envisaged that many equivalent mechanical mechanisms may be used to transmit angular drive between the foot rest arrangement 11, and the seat pan arrangement 10.

It should be noted that the second slot formation 54 is curved in nature and extends downwardly at each end. This is because the seat pan arrangement 10 is required to be in its horizontal position when the foot rest arrangement 11 at least is in its fully extended position and preferably is at both opposed limits of its pivotal movement. This is in order for the seat pan arrangement 10 to form a substantially coplanar surface with the substantially planar foot rest arrangement 11 when the foot rest arrangement 11 is in its fully extended position, thereby defining a larger size bed for a passenger to sleep on than would have been the case without the foot rest arrangement 11.

Further, typically when an aircraft is about to land and/or take off, both the foot rest arrangement 11 may be required to be in its stored position, and the seat pan arrangement may be required to be in its horizontal position.

In the embodiments shown, the curvature of the second slot formation 54 is such that the greatest angle of recline of the seat pan arrangement 10 will occur when the plane of the foot rest arrangement 11 is between 30 and 60 degrees to the vertical, and preferably at about 45 degrees to the vertical.

It will be appreciated that while the embodiments shown in the figures show the seat pan arrangement 10 being directly coupled to the foot rest arrangement 11, it is envisaged that in alternative embodiments, the seat pan arrangement 10 may be decoupled and moved independently of the foot rest arrangement 11. In this way, the seat pan arrangement 10 can be moved to its reclined or inclined position when the foot rest arrangement 11 is in either its stored position, or in its fully extended position 1.

It is envisaged that in one embodiment, the coupling pivoting member 32 may be configured and adapted to be pivoted about its coupling pivot axis 34 by at least one electric motor (not shown), thereby mechanising movement of the seat pan arrangement 10 and foot rest arrangement 11. However, for the purposes of airline seating, where weight is a critical factor, it is envisaged that the articulated coupling 30 will be manually moved by a user or passenger exerting a force for example to the foot rest arrangement 11 directly or via a handle 70 located towards an edge of the foot rest arrangement 11.

The seat 6 further includes a locking mechanism (not shown) for locking in selected positions one or more selected from the seat pan arrangement 10, the foot rest arrangement 11, the articulated coupling 30, and the coupling pivoting member 32. It is envisaged that the locking mechanism could operate by way of a positive mechanical lock, or a friction lock, or the like. It is envisaged that locking of the locking mechanism may occur passively, and unlocking actively.

Since the seat pan arrangement 10, the foot rest arrangement 11, the articulated coupling 30, and the coupling pivoting member 32 are coupled to each other, preventing movement of one of these will in effect lock the position of the rest of them, unless one or more of these is independently decoupled from the others as described.

It is envisaged that the locking mechanism could lock the one or more of the seat pan arrangement 10, the foot rest arrangement 11, the articulated coupling 30, and the coupling pivoting member 32 at predetermined positions (for example at its extremes of movement, and/or when the foot rest arrangement is at 45 degrees to the vertical) or allow locking of the foot rest arrangement 11 in variable positions.

A further feature the present invention may provide is the ability of at least some of the arm rests 20 in a row to fold away clear of the passenger seating space. In a preferred embodiment this is achieved by at least the armrest(s) 20 that lie(s) between the seats (that is the interior arm rest(s)) pivoting about a horizontal axis (not shown). The armrest(s) 20 have a deployed position in the passenger space where passenger can utilize them, e.g. to lean on when seated, and they help define the individual seat units 6. The armrest(s) 20 can pivot from the deployed position to a stowed position about the horizontal axis where they are substantially out of the way of passengers. In the preferred embodiment the stowed position is in a cavity 22 formed between two adjacent seat backs 12.

In a preferred embodiment an underside of an arm rest 20 that presents when in the stowed position is upholstered or clad to give a more compliant surface, should for example, a passenger lean back on the arm rest 20 when stowed.

A further embodiment of the invention may include at least one tray table arrangement 80 that is mounted to the rear of a seat back 12 to provide a surface for an associated passenger seated behind the seat back 12 to use. The tray table arrangement 80 can be deployed for use or stowed out of the way when not required. It also has various partially deployed states.

The table comprises a base panel and multiple extension panels which can be moved to increase or decrease the usable surface area of the tray table arrangement 80.

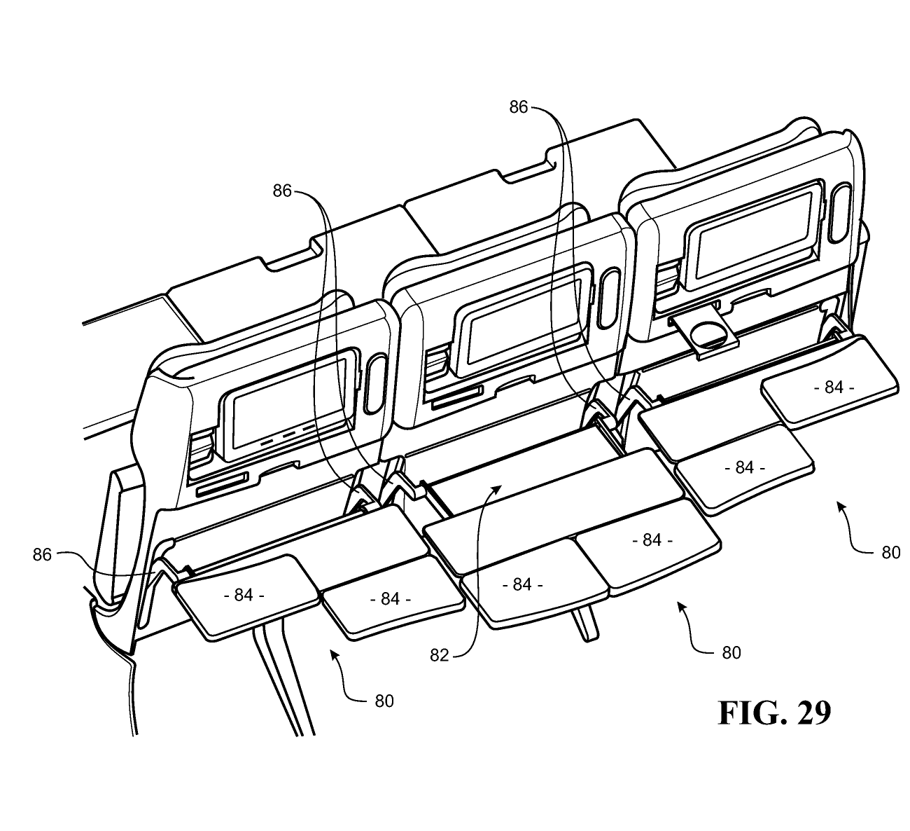

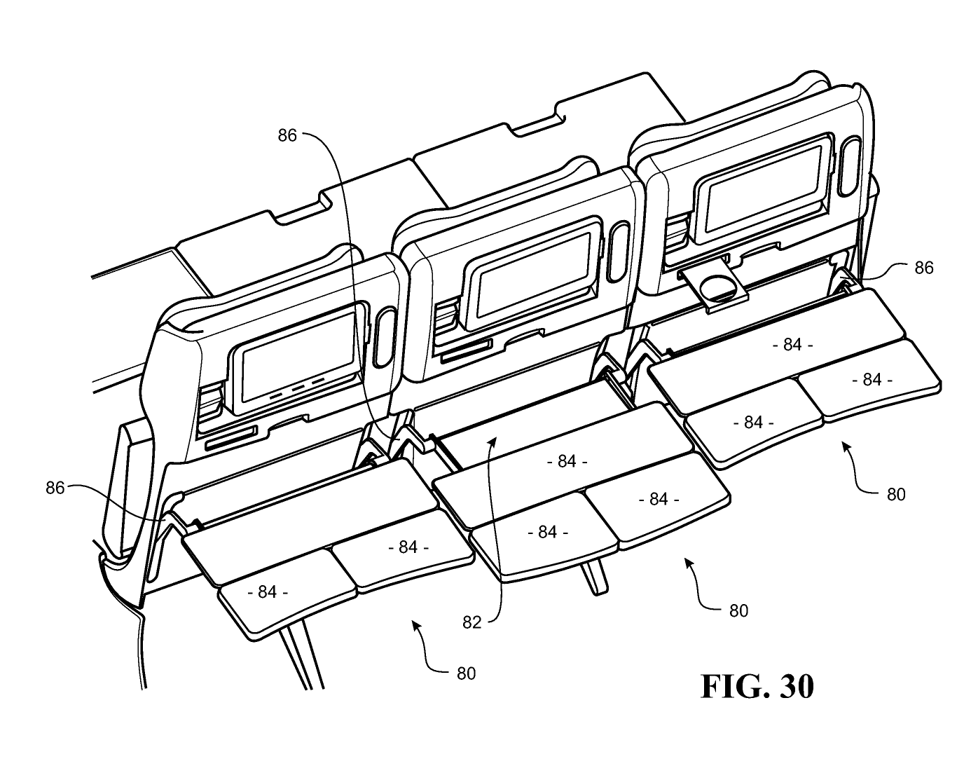

The base panel 82 is pivotally mounted to an arm 86 or pair of arms 86 that fold down from a stowed position in which a major face of the base panel abuts the seatback in front, to a deployed position. It is envisaged that at least one of the extension panels 84 may be slidably mounted to the base panel 82. It is further envisaged that other extension panels 84 may be pivotally mounted to the base panel 82 or the slidably mounted extension panel 84, or both. The slidably mounted extension panel 84 can slide horizontally at least when the tray table arrangement 80 is in its deployed position toward and away from its associated passenger. In a preferred embodiment as shown in FIGS. 29 and 30, two pivotally mounted extension panels 84 are pivoted or hinged from the edge of the slidably mounted extension panel 84 closest to the passenger. The two pivotally mounted extension panels 84 are pivotable between a first position in which they are folded together on top of the slidably mounted extension panel 84 such that their major faces are in face to face contact with each other, and a second position, in which either one or both of the pivotally mounted extension panels 84, can be pivoted or hinged from a folded position into a deployed position such that the table top surface is increased toward the passenger.

Alternatively the pivotally mounted extension panels 84 could hinge from any edge of the base panel 82.

Alternatively the pivotally mounted extension panels 84 could pivot or hinge from each other and as well as one of them pivoting or hinging from the slidably mounted extension panels 84.

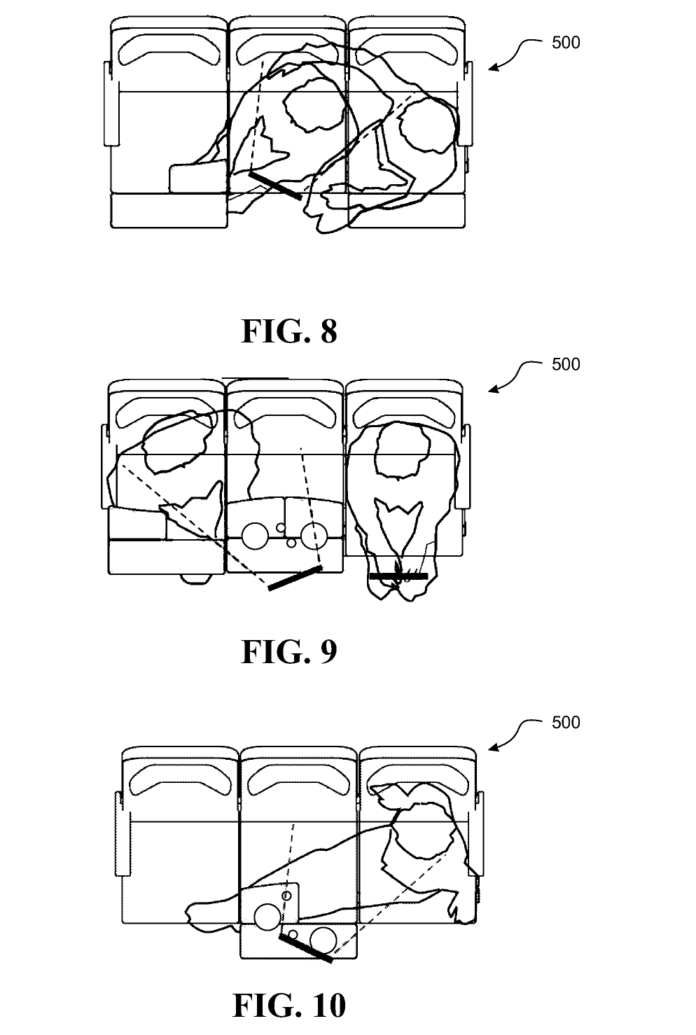

In the preferred embodiment two or more tray table arrangements 80 for a row of seats can act in concert to provide various table arrangements for the passengers in the row of seats. It is envisaged that the various available configurations of the tray table arrangement may be used in combination with the many available configurations of the seats as a seating system 500 to provide a high degree of flexibility and usability for passengers of various sizes and groupings, a shown in FIGS. 8-28.

For example, a tray table arrangement for the middle of a row of 3 seats may be fully deployed, the foot rest of that seat being in the stored position to allow a passenger in that seat to be sedentary. Passengers in the adjacent seats may sit on the fully extended foot rests of their respective seats to allow them to sit in a more communal manner with the passenger in the middle seat and utilise the tray table arrangement in desired manner. This can help facilitate more comfortable or desirable interactivity between passengers in a row.

Partially deployed tray table arrangements and tray table arrangements of variable configuration can also help with passenger accessibility and usability of their seating environment.

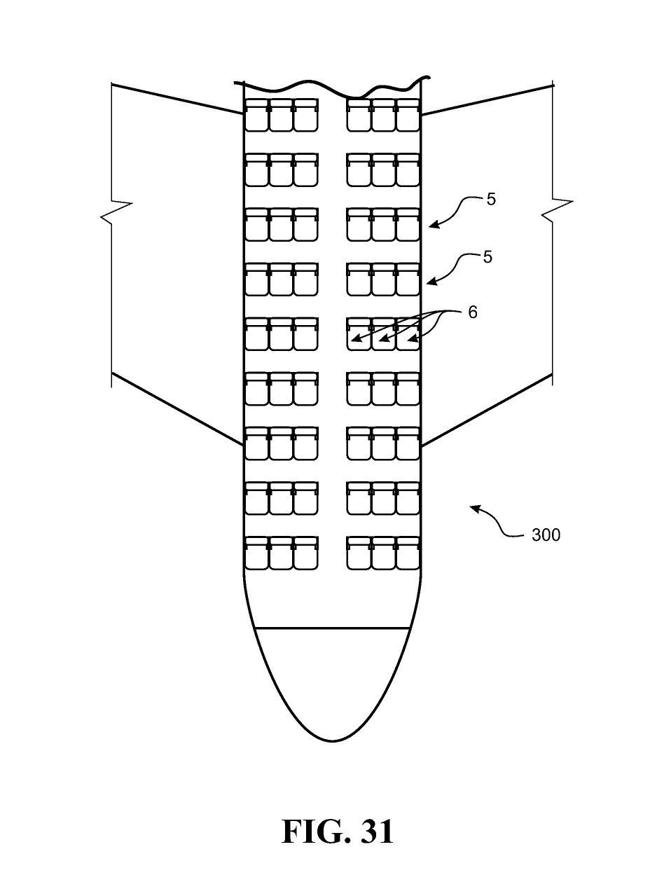

As shown in FIG. 31, it is envisaged that an aircraft may include columns (when viewed in plan) of seat units, with the seat units arranged in rows, and preferably rows of three. As an example, the seat units could be arranged in rows of three as two columns separated by an aisle.

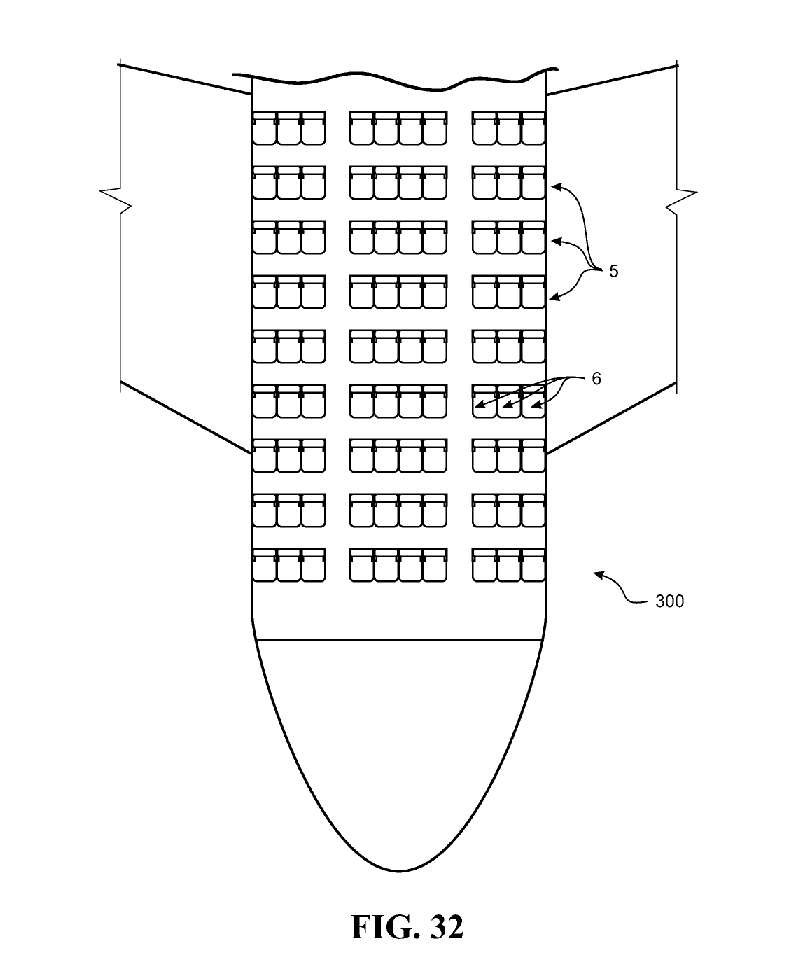

In another embodiment for a larger plane, and as shown ion FIG. 32, it is envisaged that two columns of seat units arranged side by side and three-abreast could be separated by another column of seats with an aisle on each side. The separating column of seats need not be the currently claimed seat units, but may be any known seats.

Method/System for Allocation/Reservation of Seats

According to an aspect of the invention, it is envisaged that the particular features of the passenger seat arrangement, and seat units, or seating systems as described above lend themselves for use with methods or processes of allocating and reserving vehicle seating according to the invention, as carried out by vehicle seat allocation and reservation systems according to the invention, some embodiments of which will now be described below.

In particular, the seat arrangements, seat units, or seating systems as described above lend themselves to use in a method of allocation of vehicle seating by a service provider such as an airline, and a method of reservation of vehicle seating for use by travel agents, or by users or passengers interacting with the airline service provider by means of a remote terminal 3010 such as a personal computer (PC) connected to the Internet.

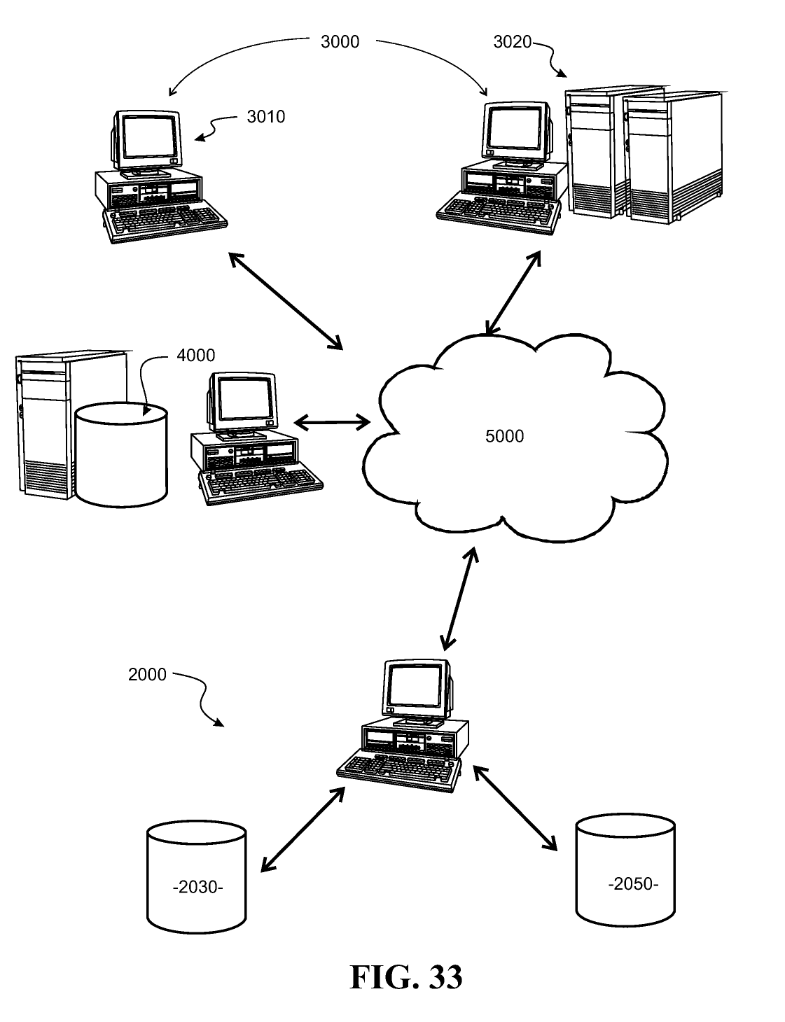

It is envisaged that the method of allocation of vehicle seating will be carried out at least in part by means of a computer implemented vehicle seat allocation system 2000 (as shown in FIG. 33) that will be implemented by a service provider of an “event” such as a an airline flight (i.e. the airline operator). The service provider for such an event would typically be an airline business, a bus travel business or the like, but could also be a charter management company or a travel agent.

In another aspect, there is also provided a method of allocating vehicle seating that will be carried out by means of a computer implemented vehicle seat reservation system 3000 (as shown in FIG. 33). In one embodiment, the vehicle seat reservation system 3000 that will be implemented by an internet service provider (ISP) on Internet servers 3020 for an airline, to make downloadable instructions available over the Internet 5000, for use by an Internet user. In another embodiment, the vehicle seat reservation system 3000, could be implemented as a dedicated system at a travel agent or at the offices of an airline. For this reason, two separate embodiments of the vehicle seat reservation system 3000 are shown in FIG. 33. Where the vehicle seat reservation system 3000 is installed on a dedicated terminal such as at a travel agency or at airline offices, the software involved would not necessarily need to be downloadable, and could be a pre-installed application or program. It is envisaged that the instructions of the vehicle seat reservation system 3000 would act as the “front end” of the vehicle seat allocation system 2000.

The vehicle seat allocation system 2000 itself will comprise a processor (not shown), transmitter (not shown) and a receiver (not shown) typically in the form of a network adapter card and/or Internet connection (although this could also be a wireless or other type of dedicated communications system); and at least one computer readable storage means (2010), such as a hard disk, for storing computer readable instructions (not shown) on in the form of software. It is envisaged that the instructions could be stored together as a single software application, or may be stored apart in separate modules. The instructions would perform the so called “back end” aspects of the vehicle seat allocation system 2000.

The vehicle seat allocation system 2000 further includes a seating configuration database 2030, which contains information about the particular seating configurations of particular vehicles or vehicle type, or even the seating configuration and seat properties for a particular flight event. Seat properties information could include information on whether the seats are of a particular configurable type, as well as the particular configuration of a seat, and which seat it lies adjacent to.

The vehicle seat allocation system 2000 further includes a s seating reservations database 2050, configured for storing information about which seats have been allocated, the classification under which the seats have been allocated, the passenger to which the seats have been allocated and other linking information which is discussed below.

The vehicle seat reservation system 3000 will similarly comprise a processor (not shown) such as that found in a server or PC, a transmitter (not shown) and a receiver (not shown), typically in the form of a network card and Internet connection; and at least one computer readable storage means, such as a hard disk or server, for storing computer readable instructions (not shown) on in the form of software, or could be embodied as embedded software on a chip. It is envisaged that the instructions may be stored together as a single software application, or may be stored apart in separate modules, and could be downloadable as discussed above.

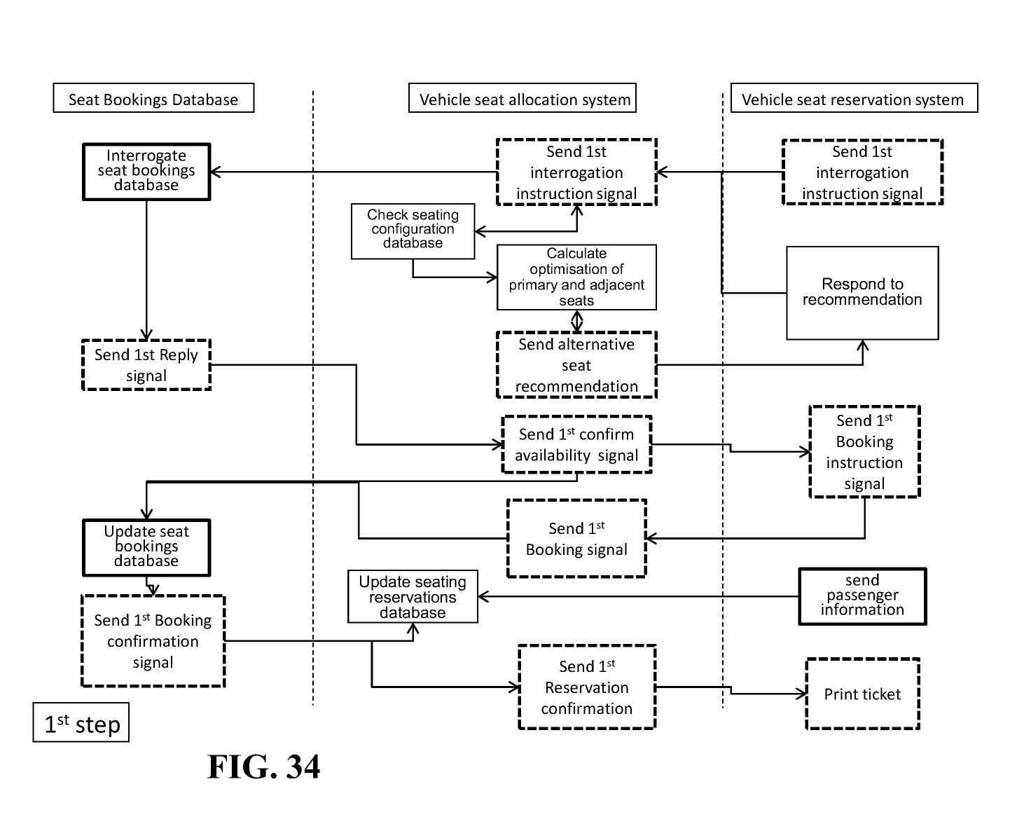

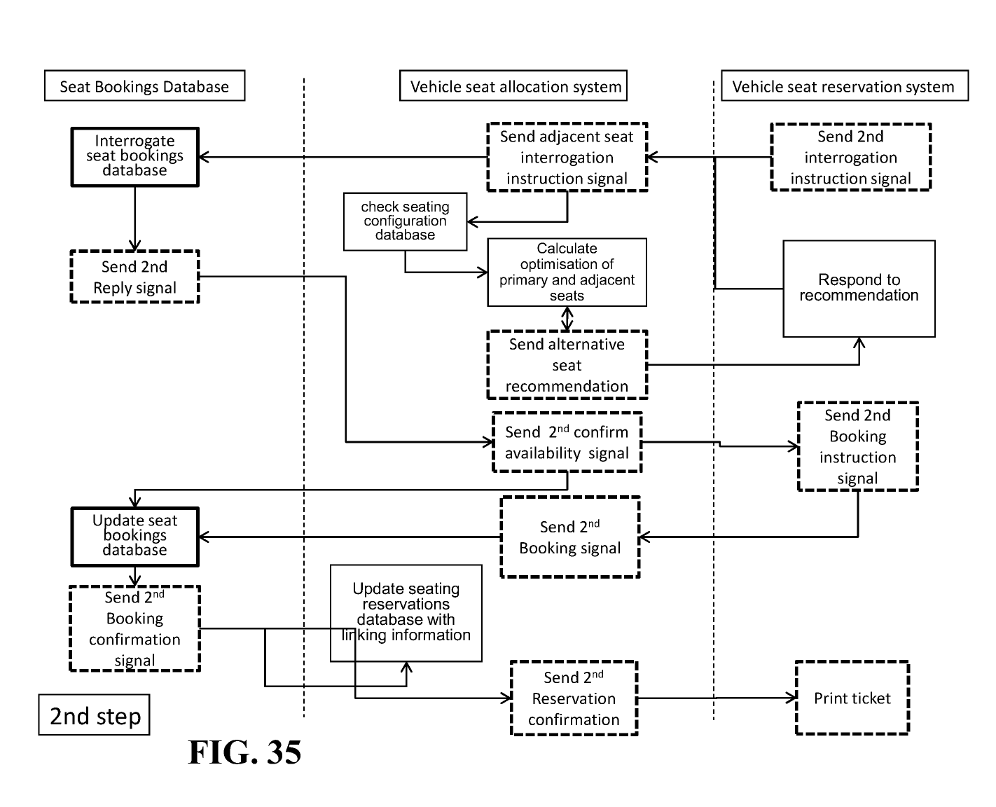

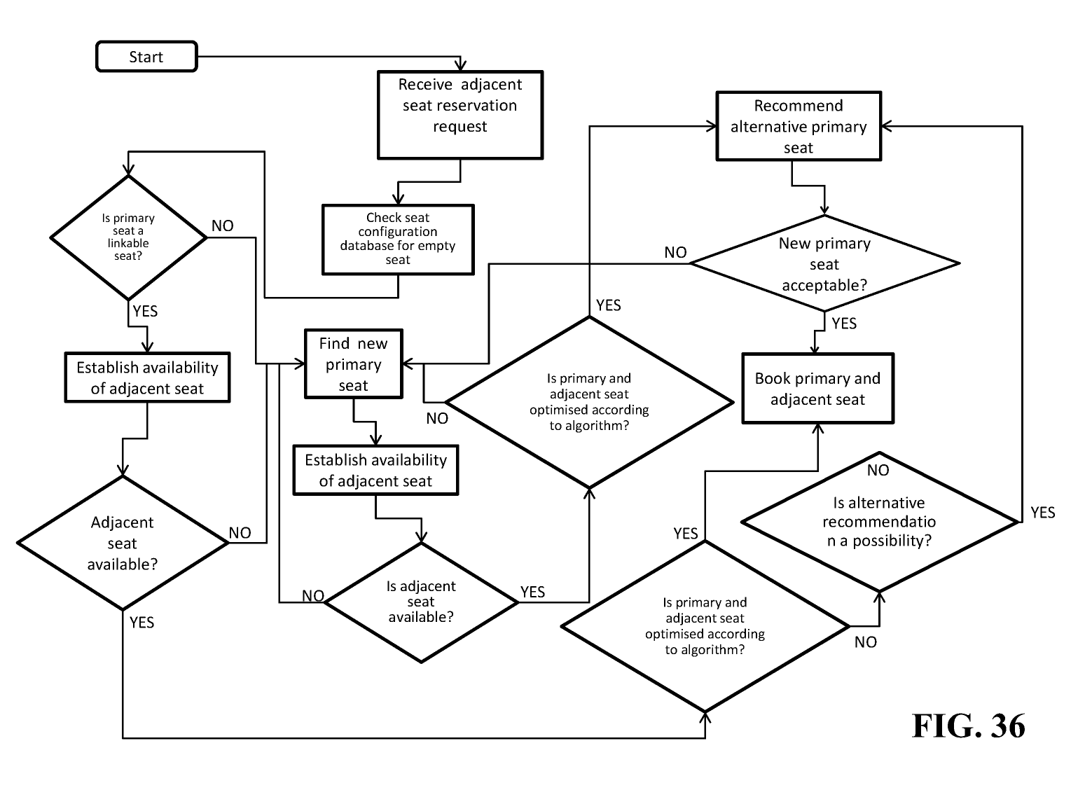

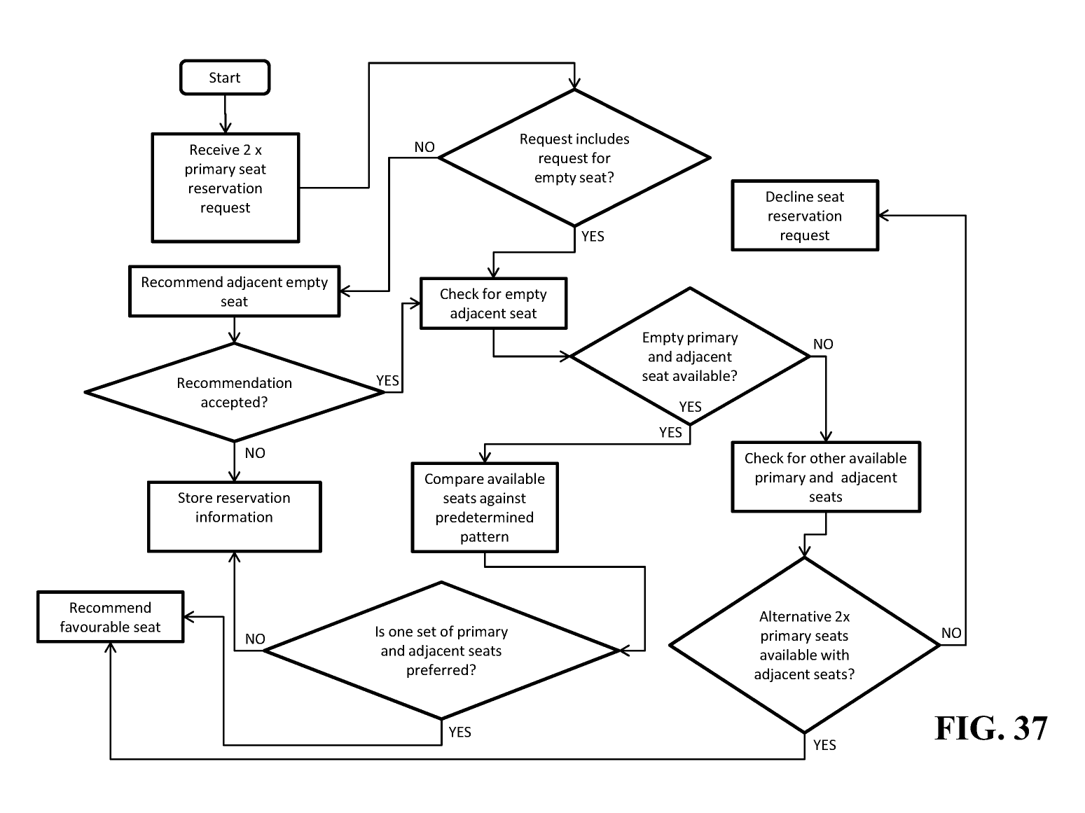

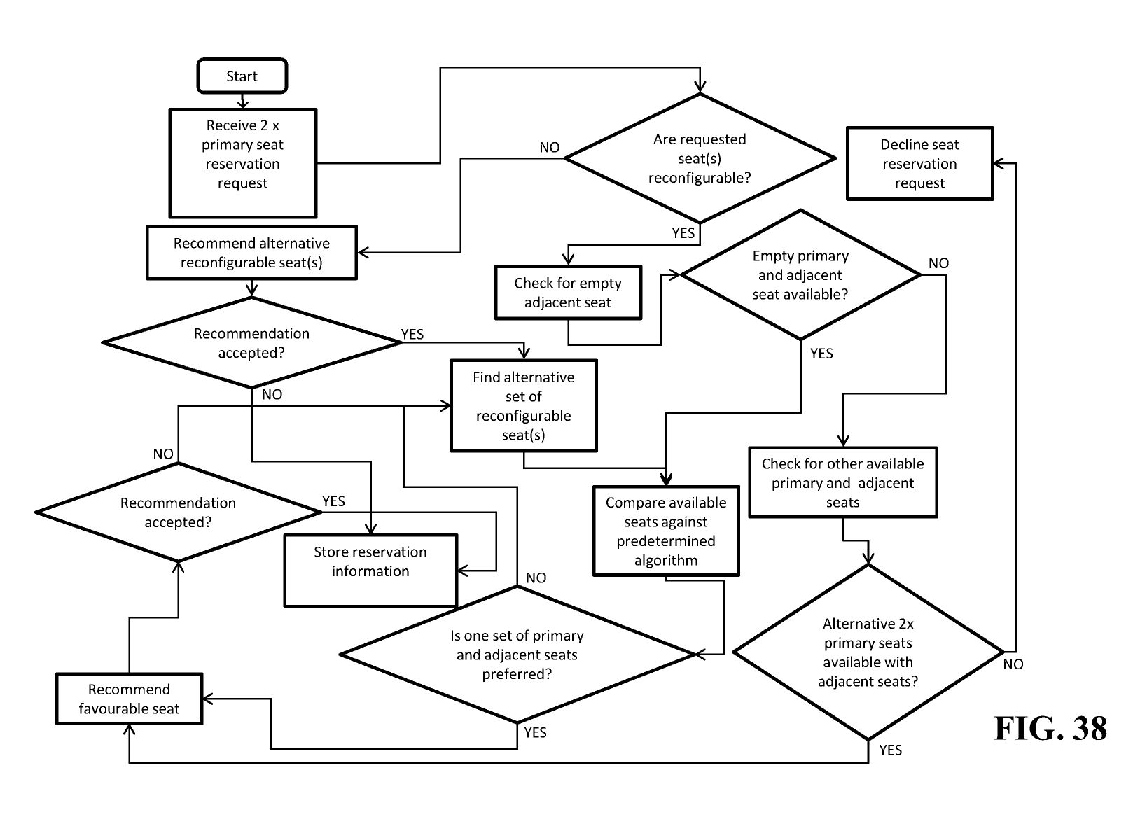

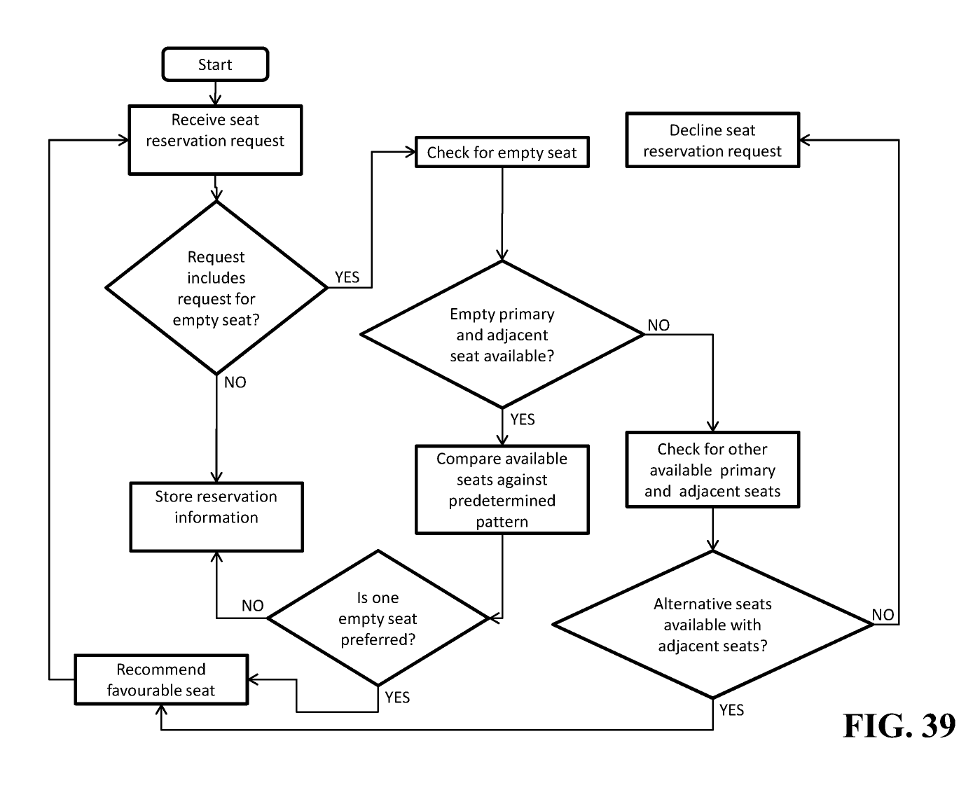

The stored instructions for the vehicle seat allocation system 2000 are configured for carrying out a number of steps of a method of allocating vehicle seating (as shown at least in part in FIGS. 34-39). These instructions will also interact with stored instructions for the vehicle seat reservation system 3000. The instructions of the vehicle seat reservation system 3000 are similarly configured for carrying out the steps of a method of reserving vehicle seating. The interaction of these systems and methods may be seen in FIGS. 34 and 35.

The methods of reserving and allocating vehicle seating will now be described below with reference to FIGS. 34 and 35, which together illustrate a first and second part of a single method.

An airline customer will approach a travel agent, or search online from a remote terminal 3010 such as a home computer or a travel agents booking system computer for a preferred airline provider's available flights and seats available on that flight. The customer will cause the remote terminal 3010 to transmit a first interrogation instruction signal for causing the interrogation of a remote seat bookings database 2020.

The first interrogation instruction signal will be received by the vehicle seating allocation system 2000. The instructions of the vehicle seating allocation system 2000 will then cause a first interrogation signal to be transmitted via the transmitter for interrogating a seat bookings database 4000 of stored seating information, in order to check for the availability of a primary seat or a plurality of primary seats in a seating configuration of a vehicle for a particular event, such as a flight. A particular primary seat number need not be put forward to check for its availability, but that the first interrogation signal may instead cause the seat bookings database 4000 to return an indication of all seats that are available for a particular flight. Instead it is envisaged that a particular number of seats will be proposed as primary seats.

The seat bookings database 4000 could be kept by the airline provider itself, or that the interrogation signal could be transmitted to a third party provider such as the “Galileo™” database (or collection of databases), that keeps record of the availability of all seats for all scheduled flights throughout the world.

The step of interrogating the seat bookings database 4000 is envisaged as including two steps—that of transmitting a first interrogation signal to a remote seat bookings database 4000 or to a local seat bookings database 4000 to cause its interrogation for available seats, and of receiving a first reply signal from the seat bookings database 4000 indicative of what seats are available. The first reply signal would be in the form of data that provides an indication of a seat number, data that provides an indication in the affirmative or the negative, and possibly data showing the layout of the seat in a seating configuration. In another format, it could only show instances where the number of proposed primary seats are available adjacent each other.

It is envisaged that at this stage, the availability of the seat or a number of seats would be reported to the remote terminal 3010, by transmitting a suitable first availability signal. If the primary seat(s) are available, then the first availability signal will be in the affirmative, and if not, the first availability signal will be in the negative. The first availability signal will include data that provides an indication of a seat number, seat numbers that fit the proposed number of adjacent seats, data that provides an indication in the affirmative and/or the negative as to availability of the seat, and possibly data showing the layout of at least one seat in a seating configuration.

In a preferred embodiment, all the available seats (perhaps for a particular class of seating) of a flight event that have been returned from the seat bookings database 4000 will then be checked against the seating configuration database 2030 to see which of the available seats are of a type that are reconfigurable with an adjacent seat to form a horizontal sleeping surface, and if any such adjacent seats are available.

Where the option exists, a recommendation could be sent to the remote terminal to show that a reconfigurable seat exists, and is available, and questioning whether the customer would be interested in provisionally reserving one or more adjacent seats to the primary. If a response is receive in the affirmative from the remote terminal, an optimized position for the proposed number of primary and adjacent seats are calculated from those available sets of seats. It is envisaged that the optimization of the allocation of these sets of seats could be according to a number of predetermined algorithms.

In particular, where two primary seats are proposed to be reserved, the instructions would interrogate the seating configuration database 2030 to see if the proposed primary seats and any adjacent seat are reconfigurable between single seat configurations and a horizontal double bed configuration on which at least two passengers can lay side by side.

Where a particular primary seat or seats are put forward from the seat reservation system 3000 to be reserved (instead of a general interrogation of which ones are available or as a selection of the ones indicated to be available) then it is envisaged that in one embodiment, the instructions of the vehicle seating allocation system 2000 are configured to check the seats against the seating configuration database 2030 to see if those primary seats are of a type that are reconfigurable (or “linkable”) with any adjacent seats, and if any adjacent seats are available for reservation. If the answer to this interrogation is in the negative, then the instructions are configured for questioning whether the customer would be interested in provisionally reserving an adjacent seat, and/or recommending an optimized primary seat with an adjacent seat available.

Once the availability signal is received at the remote terminal 3010, this is displayed to the user. Once the user decides on a preferred seat, this user will input their decision into the remote terminal 3010 and a first booking instruction signal will be sent to the vehicle seating allocation system 2000. The vehicle seating allocation system 2000 will then cause a first booking signal to be sent to the seat bookings database 4000 to cause the indicated availability of the primary seat(s) in the seat bookings database 4000 to be changed to show that the primary seat(s) are reserved and unavailable. It is envisaged that where the first booking signal is sent to a remote database such as the Galileo™ database, a further booking signal will be sent to a seat reservations database 2050 operated by the airline service provider as their own record of transacted seating arrangements made.

In an alternative embodiment, the first booking signal could be sent without sending an availability signal to the remote terminal 3010, wherein the first interrogation instruction signal indicates that a particular number of primary seats are to be booked, regardless of the particular seat details, or that a specified seat must be booked. This is an important aspect that will be described in more detail below.

It is envisaged that a first availability signal indicating availability of the primary seat will be transmitted to the remote terminal 3010 for display to a user. The customer will then cause their instruction to be input to reserve an available primary seat. After this, a first confirmatory booking signal is transmitted from the transmitter of the vehicle seat reservation system 3000 to be received by the receiver of the vehicle seat allocation system 2000, instructing the airline to reserve the primary seat on behalf of a passenger.

A first booking signal is then sent from vehicle seat allocation system 2000 to the seat bookings database 4000 to cause the indicated availability of the primary seat to be changed to show that it is reserved and unavailable. It is envisaged that passenger information associated with the booked primary seat will also be input into the remote terminal 3010 by a customer or travel agent. The passenger information will be sent from the remote terminal 3010 to the vehicle seating allocation system 2000.

Where an indication in the linking information exists that a particular seat location is not negotiable, then the software will not make a recommendation of an alternate and or optimized location of a primary seat, or set of primary and adjacent seats.

In one preferred embodiment, the passenger information need not be sent to the remote seat bookings database 4000 (although they could be if required), but will be stored in a seating reservations database 2050. Other information that will also be stored in the seating reservations database 2050 as the airline service provider's record of the seat reservations is envisaged as being the passenger information, as well as their booked primary seat number.

This stored information is together referred to as linking information, as it records the links between passenger information with the primary seat booked for that passenger. Linking information kept in the seating reservations database 2050 will be for the record of the airline service provider.

Once a primary seat has been reserved, an adjacent seat may be linked to it in the way described below. In a similar fashion to the first booking operation, a second interrogation instruction signal is sent to the vehicle seating allocation system 2000 from the remote terminal. The second interrogation instruction signal also instructs the vehicle seating allocation system 2000 to interrogate a seat bookings database 4000 for the availability of a seat on a flight that is adjacent to a primary seat. The second interrogation instruction signal may be sent together with the first interrogation instruction signal or after at least some specific details of the intended primary seat are known.

As shown in FIG. 35, a second interrogation instruction signal is then sent from the vehicle seat reservation system 3000 to the vehicle seating allocation system 2000 after input from the customer. It is envisaged that this second interrogation instruction signal could be sent concurrently with the first interrogation instruction signal, to result in a general interrogation of the seat bookings database 4000 for all available seats.

The software of the vehicle seating allocation system 2000 then causes a second interrogation signal to be sent to the seat bookings database 4000, which then returns an affirmative or negative second reply signal. If an affirmative second reply signal is returned then this result may be transmitted to the remote terminal 3010 for further instruction by a customer. The customer may then input an instruction, causing a second booking instruction signal to be sent from the remote terminal 3010 to instruct the vehicle seating allocation system 2000 to reserve the adjacent seat.

However, in another embodiment, if an affirmative second reply signal is returned, the vehicle seating allocation system 2000 may respond directly, causing at least one adjacent seat to be booked by sending a second booking signal to be sent to the seat bookings database 4000 to cause the indicated availability of the primary seat(s) in the seat bookings database 4000 to be changed to show that the primary seat(s) are reserved.

Again the first and second signals may be sent concurrently to book both the primary and adjacent seats at the same time.

Once the adjacent seat(s) have been reserved on the seat bookings database 4000, it is envisaged that further linking information will be stored in the seating reservations database 2050, to show that the primary seat(s) and the adjacent seat(s) are linked and the adjacent seat(s) have been provisionally reserved in association with the primary seat(s) for a particular passenger or passengers. Again, the linking information for the primary and adjacent seats may be stored at the same time as well.

It is envisaged that the linking information will include data such as passenger details, including one or more of passenger name, passenger nationality, passenger or customer loyalty club membership details; passenger disabilities; and passenger physical features (such as height). The linking information could also include data such as one or more of information indicative of the adjacent and/or primary seat numbers; payment details (such as whether payment has been pre-paid or is still outstanding; and whether the passenger is travelling with small children.

In one preferred embodiment, it is envisaged that a customer could include a bid amount for a monetary value when reserving and paying for the primary and adjacent seat. The bid amount would in particular be associated with a primary seat. The implications of this bid will be discussed in more detail below.

Once the primary seat(s) and adjacent seat(s) have been reserved and stored in the seating reservations database 2050 and the seat bookings database 4000, confirmation of this will be transmitted to the remote terminal 3010, where confirmation of this will be displayed to a user of the remote terminal 3010.

It is further envisaged that a printable signal will be sent to the remote terminal, where the signal can be printed as confirmation of the bookings made.

Clearly it would be in the interests of the airline to sell available seats to customers as primary seats at premium rates, and to encourage the provisional reservation of the adjacent seats at lower rates to encourage revenues from unreserved seating. However, there remains the problem of establishing when a provisionally booked adjacent seat reservation becomes finalized, and communicating this to the passenger or the person who provisionally booked it.

In one embodiment, a solution is offered by way of making the reservation and allocation of primary seats a priority which overrides those provisional bookings of adjacent seats, and then establishing or generating a cutoff date at which the provisional reservations of the adjacent seats are finalized, and no more primary seat reservations are accepted.

According to another embodiment, where not sufficient adjacent seats are available for passengers of all of the primary seats that want one, then adjacent seats can be allocated according to a predetermined priority. A priority for allocation of adjacent seats can for instance be created by comparing the linking information associated with a primary seat to the linking information of another conflicting primary seat. It is anticipated that primary seats having a common adjacent seat can be compared in this way, or all primary seats with allocated adjacent seats can be compared to establish a priority order for a vehicle or for a particular section of a vehicle. Linking information that can be compared in order to establish a priority include:
passenger payment details;
whether passenger has already paid for the adjacent seat;
whether the passenger or paying customer is a member of a loyalty program;
whether the passenger is travelling with children;
whether the passenger is listed as a being disabled or sick;
a passenger's physical details (such as height), and
whether the adjacent seat was the later adjacent seat allocated.

In one embodiment, the passenger payment details could include a bid amount of a monetary value as described above, which bid amount is associated with a primary seat.

When a priority order for allocation of an adjacent seat is being established, the comparison could be to establish the highest bid amounts of the primary seats being compared. This would result in passengers bidding, and (once allocation of seating is finalized) paying market related amounts according to what they believe the availability of the adjacent seat is worth, and possibly maximizing revenues from the auction of the adjacent seat.

In order to minimize the negative marketing effects of having linking details of one primary seat be compared to another and losing priority, it would be in the interests of the passengers comfort, and in the interests of the profitability of the airline to be able to optimize allocation of primary and adjacent seats to ensure the largest numbers of passengers are seated with an adjacent seat. Optimization of the seating allocation could carried out in order to maximize one or more of
passenger comfort;
passenger personal space;
commercial effect or viability.

This would occur in its most effective form by calculating and allocating the entire layout of an aircraft, or a section of that aircraft, and allocating primary and adjacent seats according to an optimization algorithm, which could take any of the linking information into account in its determination of an optimized allocation of seats.

It is envisaged that the calculations would also take into account whether any variance of the primary seating is allowable at all. This is because some passengers may have strict non-negotiable requirements for the location of their primary seats (for example, seating allocated alongside an aisle for pregnant women, maximized leg space for extraordinarily tall people, for unaccompanied minors who must be seated close to air staff, etc). For this reason, optimization of seating within such prescribed limits can also be carried out. An indication of the non-variance of the seating allocation would also be available as part of the linking information stored in the seating reservations database 2050 after the seats are initially booked.

In order to do so, it is envisaged that in one embodiment, the software of the vehicle seating allocation system 2000 would be configured to establish or receive a cutoff date, and after the cutoff date, would optimize seating allocation of primary and adjacent seats according to the number of reservations received at that cutoff date.

However, where a bid-type priority allocation is used, it is envisaged that the prioritization of allocation of seating could continue right up until boarding passes are printed.

It is also envisaged that where a bidding system is used, the initial bid submitted by a customer can be increased after the initial reservation of the adjacent, for example by upgrading the bid online, in order to obtain priority for their primary seat to be associated with the adjacent seat. In this way, an auction is envisaged between passengers who would like to ensure their comfort for a flight.

In another embodiment, the software of the vehicle seating allocation system 2000 would be configured to propose an allocation configuration for a primary and/or adjacent seat as at the time it is reserved, which has been calculated to optimize the benefits of seat allocation as at the date of reservation of those seats. This provides more certainty as to the seats being booked or the customer (although primary seats will still retain their priority status).

As an example, it is envisaged that reservations of single primary seats can be allocated down the middle rows of an aircraft, (since this will be less likely to change) while primary seats together with provisionally reserved adjacent seats can be allocated alternately to the sides rows of the aircraft. This would typically result in the maximization of the allocation of adjacent seats, at least until the sides of the aircraft have filled up.

Such allocation of seats according to a predetermined algorithm could have also have an additional benefit in that passenger placement can be allocated for optimized weight distribution of passengers throughout the aircraft, allowing the aircraft to fly more aerodynamically and hence more efficiently through the air, and possibly allowing for reduced fuel usage and fuel cost savings (which costs savings may be passed to passengers).

Again, it should be noted that the above explanation describes the allocation of the primary and adjacent seats as a method that runs in two parts in chronological sequence, it should be noted that the first and second “parts” can operate concurrently. For instance by a user identifying a primary and adjacent seats together and sending instructions for the interrogation of the seat bookings database 4000, interrogation of the seating configuration database 2030, allocation of the two seats, or update of the seating reservations database 2050 by a single action.

In another embodiment the optimization of all reserved seating can be calculated after a cutoff date, after which the customers can be informed of their finalized seat allocation. In this way, both passenger comfort and airline profit can be optimized.

In one particularly preferred embodiment, the passenger seat arrangement, seat units, or seating systems as described above are envisaged as being particularly suited to this method of allocation of vehicle seating, since a pair of passengers, such as a married couple, having two primary seats located next to each other can reserve a single adjacent seat adjacent the primary seats, and then the three seats together can utilize the features described above to form a horizontal double bed on which two passengers can lie side by side. This method of allocation would also, for example, benefit a pair of parents and an infant that would normally be required to sit on one of the parent's laps. Being able to reserve an additional seat provisionally and at a reduced price from what is normally the case, and be able to reconfigure the three seats into a bed on which all three persons can lie comfortably would result in increased passenger comfort and convenience without much increased cost. In addition it should be noted that no individual comfort is lost when the parents are required to sit up (for instance when eating, since an individual seat is able to form a horizontal sleeping surface for an infant or toddler, especially with the leg rest being able to be raised to be substantially coplanar with the seat pan.

In the manner described above, it is envisaged that a customer or passenger of an airline can be offered an upgrade from a single seat booking or reservation in a particular class of the aircraft, to a seating arrangement that will allow the passenger to assume a sedentary position, a lounging style position and a fully reclined position in that same class.

And even more conveniently, an upgrade can be offered to two companion passengers (possibly with an infant) that can both assume a sedentary position in which both passengers can lie flat in a side by side position perpendicular to the longitudinal direction of the body of the aircraft, a lounging style position and a fully reclined position utilising the seating arrangement. In a preferred embodiment, the seating arrangement is a row of at least 3 adjacent seats that each include a seat pan and a leg rest, the leg rest able to move between a stored position adjacent and extending downwardly from the front edge of the seat pan and a horizontal position wherein it provides a resting surface that is coplanar with the upper surface of the seat pan. As described above, such an upgrade offer is envisaged as being made available to the customer or passengers at or prior to check-in or boarding for the flight.

In another embodiment, the booking system, airline or travel agent can offer an airplane trip/journey to one or more passengers whereby the passengers can reserve a space such that they are guaranteed a two or more (and preferably three or four) person contiguous space. The space could be, for example, three guaranteed adjacent seats for a journey. The adjacent seats form a contiguous multi-person space, suitable for accommodating a plurality of passengers. For example, the multi-person seating space can comprise adjacent seat pans that are touching or close to each other. Alternatively, the multi-person space could be a single physical unit, rather than independent seat, although it would provide the equivalent space of three adjacent seats for passengers. That is, there would still be 3 seats/seat pans, but formed as an integrated unit. Either way, the space can be considered a single unit, as it can be configured as such. Each seat or seat pan (whether separate or integrated) forms a passenger location for a passenger to sit. Reference to the term seat can refer to a passenger location in any configuration mentioned above.

Any number of passengers up to the number of passenger locations in the space can be reserved and allocated to the space. The multi-person seating space could comprise or be made up of the seats such as shown in FIGS. 1 to 28 and as describe above with reference to them, although this is not essential. A multi-person seating space can comprise any two or more contiguous seats (either separate or integrated) that a passenger can lie across the seat pans substantially unimpeded (for example without interference from arms rests, significant gaps or other physical interferences). A multi-person seating space can be the nominal setting aside of contiguous regular seats in a plane for use as a multi-person seating space, or can be special seats physically configured or configurable into such a multi-person seating space. For example, in the case of the multi-person seating space made up of seats such as shown in FIGS. 1 to 28, the space comprises seat pans that can be configured with one or more extension surfaces such as leg rests that extend substantially co-planar with each seat pan, which in combination with the seat pans, provide additional support surface for passengers—such as additional space on which to lie down. The multi-person seating space provides the ability for those passengers to configure and use the space how they prefer, for seating and/or sleeping throughout the journey.

One embodiment of the system/method for providing this is described with reference to FIGS. 40 and 41. Referring to FIG. 40, the system comprises a seating database 4000, and a booking system 4001 operated by the airline or third party. Travel agents 4003 and/or individual customers 4004 can access the booking system 4001 via computers connected to the booking system, over the internet 4002 or other network. This system could also be used for booking according to any of the other methods described. The booking system shown in FIG. 33 could also be used.

The method operates as shown in FIG. 41. The airline can offer journeys/flights on a plane whereby a one or a group of customers (associated passengers) can reserve a multi-person space, where they can sit/sleep for the duration of the flight, step 4010. This will most likely be in lieu of booking a single seat each in the usual manner. The offer can be made from the booking system, over the internet, or via any other advertising channels.

The customer (e.g. directly or via a travel agent) can access the booking system 4001, step 4011, via the computers 4003, 4004 and internet 4002. In doing so, they can request a multi-person space as a single unit, and indicate how many people are in their party who wish to travel, and therefore also be allocated in that space. Each passenger in the party becomes an associated passenger. These people are the associated passengers for the booking, and one of them nominally becomes a primary passenger. Any number of passengers up to the number of passenger locations in the multi-person space can be associated with the booking. For example, where the multi-person space is formed of three adjacent seats (or otherwise has three passenger locations for accommodating up to three passengers), one, two or three passengers can book a journey and be allocated to or associated with that multi-person space. The multi-person space can have a single identification (e.g. couch number 2) and/or also be identified by the seats that comprise the space (e.g. seats 1a, 1b, 1c). Either way, the contiguous space is offered and booked as a single unit, for any number of passengers up to the maximum number of passengers that the space can accommodate.

The booking system 4001 indicates the price. This will be based on numerous factors, including the number of passenger spaces, the number of passengers in the booking, the availability of passenger locations in for that flight, and other considerations. The booking system can then receive confirmation and payment, and confirm/reserve the journey along with the multi-person space, step 4012. It will update the seating database 4000 accordingly. The process will guarantee that the passengers will be allocated to the space, and not split up in non-contiguous seating or other spaces. In one option, where the number of passengers booked in for a multi-person space is less than the number of passengers the space can accommodate, the “spare” seats will be removed from the inventory. E.g., if an airline has one hundred passenger spaces in a flight, and two people reserve a multi-person space that can accommodate up to three people, the inventory will be reduced by one to 99 seats.

Once booked, one or more tickets are issued for the journey, step 4013, which are associated with the multi-person space. Preferably, each person for the booking is issued a ticket, each of which is associated with the multi-person space—i.e. it allocates the person corresponding to the ticket to the multi-person space. This might be by way of an ID reference, similar to a seat number, but which refers to the entire space (e.g. couch number 2). In this manner, there is not necessarily a ticket issued for each seat or passenger location in the multi-person space, but rather a ticket for each passenger allocated to that space. Therefore, where only e.g. two passengers book a space for a multi-person space that can accommodate up to three passengers, only two tickets are issued.

Each ticket might also nominally be associated with a particular location in the space and/or allocate the corresponding passenger to a particular location in the space (e.g. seat 1a) although this is not essential. Where there is a “spare” passenger location (e.g. where two people are booked for a three person space), the primary passenger ticket might nominally be allocated or associated with the spare space, and the primary passenger nominally allocated to the spare space. Also, the ticket revenue for any spare space might be allocated to the ticket of the primary passenger.

When the passengers check in for the flight, or at some other suitable time, the passengers receive a boarding pass, preferably one each. Each boarding pass is associated with the multi-person space (e.g. by reference such as couch number 2). This also allocates the corresponding passenger to that multi-person space. Each boarding pass might also be nominally associated with a particular location (e.g. seat, such as 1a) in the multi-person space, and the corresponding passenger nominally allocated to that space. This will be consistent with the ticket associations/allocations. The primary passenger boarding pass might be associated with spare locations also (e.g. 1a and spare location 1b), and nominally locate the corresponding passenger to those locations.

With the present embodiment, it is not necessary to issue a separate ticket and/or boarding pass for each seat or passenger location. Rather, each passenger receives a ticket/boarding pass, which correlates to the space and/or individual passenger locations in that space. Therefore, the number of boarding passes and/or tickets issued for a multi-person space might be less than the number of passenger locations in that space.

In one example, three adjacent seats forming a multi-person space. These can be booked by one, two or three people as a block. If one person books, they receive one boarding pass and ticket associated with the multi-person space, and optionally associated with the seats in that space (e.g. 1a, 1b, 1c). If two people book the space, two tickets/boarding passes are issued one for each passenger, each associated with the space. The primary passenger ticket/boarding pass might be associated with a seat, and also the spare seat in the space, with the secondary passenger ticket/pass being associated with the other seat in the space. If three people book the space, each receives a boarding pass and/or ticket associated with the space and/or individual seats within the space.

This above method could also apply for multi-person spaces with two, four or more locations. A contiguous multi-person space will be guaranteed upon booking. The airline will not rearrange the passengers for the booking into non-adjacent seating at a later stage.

The space will preferably comprise guaranteed adjacent contiguous seating, which could be configured into a bed and/or a single space and/or individual seating, as required. The seats could be those in FIGS. 1 to 28. This might allow the seating to be sold as individual seating on different occasions, as required. However, the space could also be a dedicated couch, bed and/or single space which can accommodate multiple adult people, solely for the purpose of being reserved as a single space for travelling passengers.

An alternative embodiment is now described, also with reference to FIGS. 40 and 41, wherein the computer system 4001 is configured to implement a method to allocate seats as set out below. The following example assumes a three seat multi-person seat, but it will be appreciated the example could apply to a multi-person seating space with any number of seats from two. After the computer receives a request for a reservation, step 4009, the computer system 4001 determines which combinations of multi-person seating space, if any, to offer based on availability, step 4010. Several options might be offered, which could comprise a combination of multi-person seating spaces and regular seats to meet the seating requirements of the booking party. Note, the term “offer” should be interpreted widely such than any such availability might not be actually proactively offered, but just made available for request. Alternatively, there might be proactive offering of the options. The computer then receives a reservation request for a multi-person seat(s) (optionally in combination with standard seats), step 4011. Next, the computer system 4001 confirms the booking and reserves the seats, step 4012 and issues a ticket and boarding pass, steps 4013, 4014. Optionally, the ticket and/or boarding pass might be issued by different computer systems.

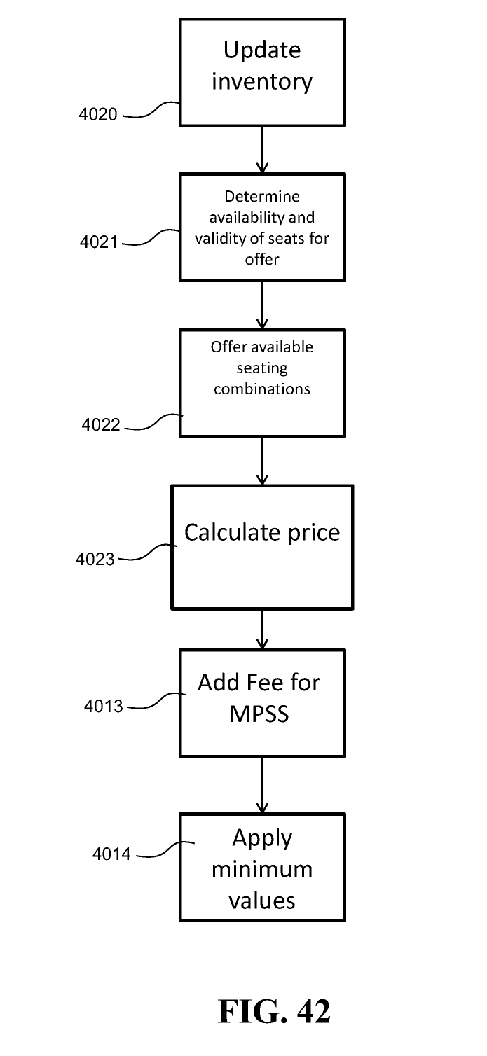

There are several steps the computer system 4001 undertakes to determine which combinations of seats to offer, as shown in FIG. 42. In a first step, step 4020, the computer system keeps and inventory which can be used to determine whether to offer a multi-person seating space based on availability. To do this, the computer system operating the passenger reservation system stores an inventory of seats for a flight in the database 4000 and controls that inventory. Based on the inventory, the computer system 4001 can determine whether a multi-person seating space is available to offer.

The inventory of seats comprises standard seats (e.g. economy class seats) and multi-person seating spaces/couch-style seating space either nominally set aside as multi-person seating seats or physically configured or configurable as such. In the inventory, each seating space in a multi-person seating space is considered a single seat. So, a multi-person seating space with three seats would be recorded as having three seats in the inventory. In addition, there will be a record of the number of multi-person seating spaces. For example, in the aircraft for a flight there might be 20 multi-person seating spaces (each comprising three seats), resulting in 60 seats which in the inventory are stored separately as a nested sub set of all economy class seats. This arrangement also means individual seats in the multi-person seating space can be sold as regular economy class seats if all other economy class seats have sold and there are still multi-person seating space seats available for sale. Preferably, an economy class seat cannot be sold as a part of a multi-person seating space at any stage—although this can be done if desired.

The following examples illustrate how the computer system could control multi-person seating space inventory for sale. A Boeing 777-319ER aircraft can be configured with 244 economy class seats; of which 60 can be nominally set aside as or specially configurable as multi-person seating space (MPSS) (60 seats=20 multi-person seating spaces). Notwithstanding a potential over booking profile for economy class, the 244 seats are designated as 244 inventory seats to sell from. The inventory can be represented as set out in the table below

| | Inventory | Seats Sold | Seats available for sale |
|---|---|---|---|
| Economy Class | 244 seats | 0 seats | 244 seats |
| Incl. MPSS | 60 seats | 0 seats | 60 seats |
| | (20 MPSS) | (0 MPSS) | (20 MPSS) |

The inventory is updated in accordance with the reservations that are made. Five possible examples are set out below.

1. Starting with a completely empty plane, if one regular economy class seat is requested/reserved it is marked as sold by the computer system, with the inventory remaining at 244 seats. That is, 244 seats available for sale one sold with 243 remaining available for sale. The table below represents this.

| | Inventory | Seats Sold | Seats available for sale |
|---|---|---|---|
| Economy Class | 244 | 1 | 243 |
| Incl. MPSS | 60 (20 MPSS) | 0 (0 MPSS) | 60 (20 MPSS) |

2. Alternatively, starting with a completely empty plane, if a multi-person seating space is requested/reserved for three associated passengers in it, one multi-person seating space is marked as sold by the computer system, and at the same time three seats are marked as sold from regular economy class (termed “raiding”). This is equivalent to selling three economy seats from the perspective of the inventory. The total inventory remains at 244, with 241 remaining available, as set out below.

| | Inventory | Seats Sold | Seats available for sale |
|---|---|---|---|
| Economy Class | 244 | 3 | 241 |
| Incl. MPSS | 60 (20 MPSS) | 3 (1 MPSS) | 57 (19 MPSS) |

3. In contrast, starting with an empty plane, if one multi-person seating space is requested/reserved that includes one ‘unoccupied’ or spare seat (e.g. two associated passengers request one three seat space), the computer system will deduct one seat from the total economy class inventory, and will mark the inventory as having two of those seats sold. In this case, the inventory reduces to 243, with the number of seats remaining unsold being as 241. In effect, the unoccupied seat in the multi-person space is removed from inventory altogether. This prevents the seat being allocated to others, yet does not require the inventory to actually allocate that seat to achieve this. The table below shows the change in inventory

| | Inventory | Seats Sold | Seats available for sale |
|---|---|---|---|
| Economy Class | 243 | 2 | 241 |
| Incl. MPSS | 60 (20 MPSS) | 3 (1 MPSS) | 57 (19 MPSS ) |

4. When all the multi-person seating spaces are requested and reserved (see table below), the computer system will no longer offer the option to request/reserve multi-person seating spaces upon receiving a reservation request for a flight.

| | Inventory | Seats Sold | Seats available for sale |
|---|---|---|---|
| Economy Class | 244 | 60 | 184 |
| Incl. MPSS | 60 (20 MPSS) | 60 (20 MPSS) | 0 (0 MPSS) |

5. However, regular economy class seats will continue to be allocated to new reservation requests. If regular economy class demand exceeds the available economy seats initially allocated as such, the computer system continues to allocate seats, but from the multi-person seating spaces as economy class seats. To do so, the system reduces the available multi-person seating spaces in blocks of three seats (one MPSS) for allocation as economy class seats, as shown below.

| | Inventory | Seats Sold | Seats available for sale |
|---|---|---|---|
| Economy Class | 244 | 185 | 59 |
| Incl. MPSS | 60 (20 MPSS) | 0 (0 MPSS) | 57 (19 MPSS) |

The computer system updates the inventory as seats are reserved according to the examples above. This keeps a tally of what is available for offer.

If a multi-person seating space is available for offer, the next step, step 4021, is to determine whether it can be offered based on an economy class booking. To do this, the computer system interrogates the reservation for a flight to determine if the booking class of that reservation is a valid class to offer a multi-person seating space for. Next, if the booking class determined above is a valid class, the computer system 4001 then determines if there are actually sufficient multi-person seating spaces available (based on the inventory set out above in step 4020) to offer any or all options, as determined in the next step below (see step 4022). If there are sufficient seats available, the computer would normally offer the required number of multi-person seating spaces (and regular seats where necessary) appropriate for the number of associated passengers in the flight reservation. However, if there are not sufficient, the computer system limits the options offered in the step below based on this information.

For example, the reservation request for a flight for associated passengers (“booking”) might contain six associated passengers, but there is only one multi-person seating space remaining available for reservation. For this request, the computer system would need to limit the offer to just one multi-person seating space. Standard economy class seats would be allocated for the remaining passenger requirements.

The next step, step 4022, is for the computer system to determine the possible combinations of multi-person seating spaces and/or economy class seats to offer that will provide the seating requirements (that is, the required number of seats) for the associated passengers for the flight reservation. In one option, the computer determines the three most logical configurations of multi-person seating spaces and regular seats for the booking party. This determination is based on interrogating a booking to see how many passengers are in the booking and how many children are included and also an interrogation of the seating inventory to see what is available. In many cases there are more or fewer than three options that could be offered, so offering three options is just one variation—other numbers of options could be offered where appropriate.

Some examples of what can be offered are set out in the table in Appendix A. For example, when a booking party of three request a multi-person seating space, they could be offered one multi-person seating space and a regular economy seat, resulting in four seating spaces for three people; or alternatively simply offered a single multi-person seating space, resulting in no spare seats. In another passenger combination, three adults and one child might be offered one multi-person seating space and two regular economy seats for two spare spaces; or alternatively just a single regular seat resulting in one spare space. The table is one example only of possible offering combinations, and should not be considered limiting.

Further, in addition to offering possible combinations of multi-person seating spaces and regular seats, the best spatial configuration(s) of those seats could also be determined, offered or selected by the customer and/or computer system. That is, as part of the request for a multi-person seating space, the customer making the booking has the opportunity to select which actual seats in the plane they will be allocated to. For example, if two adults and two children are travelling, they could be offered/select one regular seat across the aisle from a (three seat) multi-person seating space. This means the party can more easily swap seats during the flight. So for example, during part of the flight one adult might entertain the children in the multi-person seating space, while the other party relaxes in the regular seat. Later, the adults could swap positions. In other examples, with a party of four people, two multi-person seating spaces could be offered. In one option, they could be in separate but adjacent rows, allowing easier communication (This could be desirable, for example, if the passengers are adults), or alternatively they could be in the same row, adjacent across an aisle, allowing for better visual contact (this could be desirable, for example, if the party contains children). Any suitable variations can be offered that might best suit the way the passengers in the party intend to utilise the combination of multi-person seating spaces. Depending on the availability, they may get several options for selection.

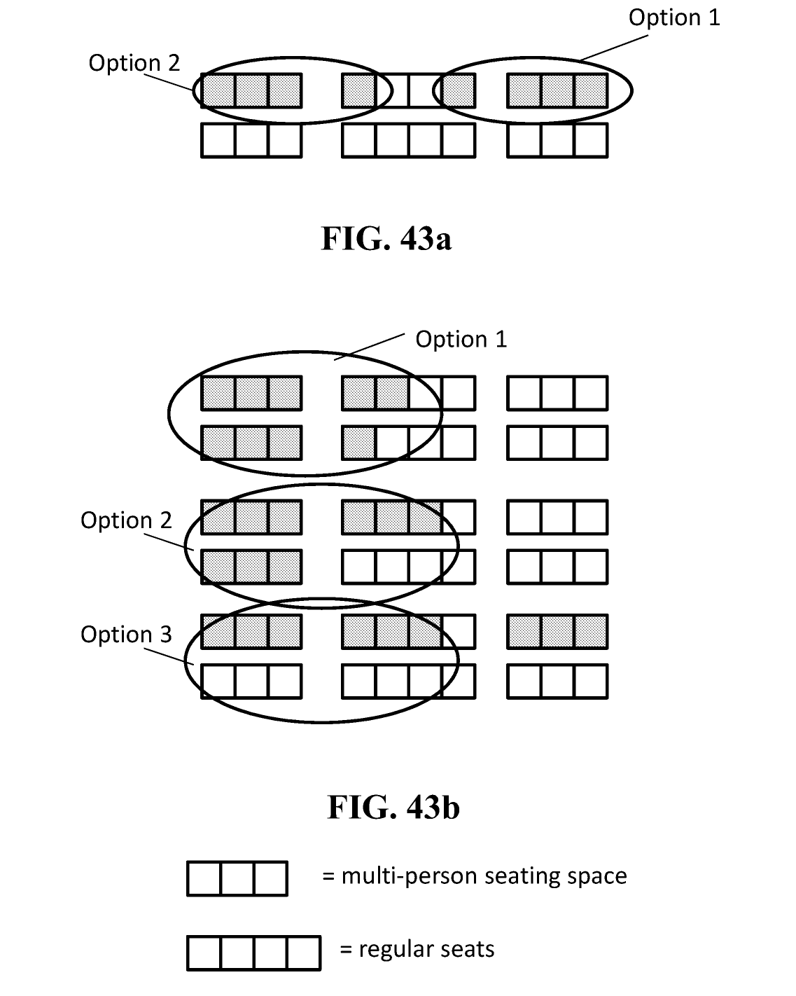

Actual examples of configurations are shown in FIGS. 43a, 43b, with reference to a typical seating configuration on a Boeing 747, comprising multi-person seating spaces at the sides, and 4 regular economy seats in the middle. For example, three people being offered one multi-person seating space and a regular economy seat might get to choose any of the physical configuration combinations shown in FIG. 43a. With larger bookings (e.g. a request comprising two multi-person seating spaces and three regular economy seats) more alternatives will be available, see FIG. 43b. As will be appreciated, a large number of other alternatives are possible. Preferably, the middle section of four regular seats will be initially reserved for selection by those who are selecting multi-person seating spaces, and need additional regular seats as part of their booking. If other regular seating spaces run out, or if only a multi-person seating space on a row is required, the middle section of regular seats will then be freed for general selection by any passengers. Any suitable variations for any of the possible offerings could be selected. Of course, the options will be dependent on availability. Once the seats are allocated and selected, associated passengers in the booking party will be free to choose between themselves where and how to sit in those allocated seats during the flight. In this way, the individual seat allocations become less relevant, rather all the space allocated to the booking party (in the form of multi-person seating spaces and regular seats) are made available to the passengers of the booking party for their exclusive use to use how they please during the flight. They can sit or lie, reconfigure the seats as desired and/or use any spare seating as desired. The entire seating allocation becomes a space for use, rather than individual seats for sitting on, as in the traditional sense. The next step, step 4023 is to determine the value of the seats on offer. Each option offered may include a number of unoccupied/spare seats. This usually occurs when the number of seats (passenger locations) available in the combination being offered exceeds the number of associated passengers in the booking party. Examples include, two adults sitting in one multi-person seating space resulting in one unoccupied seat; or three adults and one child sitting in two multi-person seating spaces resulting in two unoccupied seats. The computer system then determines the displacement cost (value) of the spare seats in each of the combinations of seats being offered. This enables the seats to be priced for sale. Note, where the number of passengers is equal to the number of passenger locations, usual pricing can apply, although a premium might be applied for a multi-person seating space that is specially configured as such as it provides additional benefits over normal seats. Alternatively, the method below can still be used.

The value can be calculated in any suitable way. In one possibility, to calculate any displacement cost a optimisation engine forming part of the computer system 4001 generates a spare seat value (such as a Expected Marginal Seat Revenue (ESMR)) for a set number of unoccupied/spare seats (e.g. the first twenty) for every flight on sale. The optimisation engine forecasts the number of passengers/seats that will be sold for the flight, and also a value for every seat in inventory for the flight should they actually be sold. The spare seat (e.g. ESMR) value is set as a value for the ‘next’ sale of a seat that was not forecast to sell. That is, the optimisation engine is used to forecast the number of seats expected to sell for each departure which is based on historical data and applied demand factors. For example, it may predict that 100 of 244 seats will be sold. The forecast being a forecast may or may not be correct. It will also determine a value that each of those seats should be sold for. The spare seat value is the value of the next sale in the forecast according to the optimisation engine. As the optimisation engine is not designed to sell spare seats (i.e. the next sale of a seat) the spare seat value is used to determine the raw value of the spare seat. The following steps are then carried out to determine a price for the offering.
a) The spare seat values for each flight are passed to the computer system, which calculates how many spare seats are required to sell each configuration of the multi-person seating space offered (up to three).
b) If one spare seat is required then the computer system takes the first spare seat value. If two spare seats are required to sell a multi-person seating space then the computer system takes the first and second spare seat values and adds them together. Once spare seats are sold the related spare seat values are recorded as sold and the next spare seat values are used to calculate the next value of spare seats.
c) The computer system then rounds up the total spare seat value to a predetermined band for each region of sale, e.g. USA price bands may be in $100 increments while the UK may use £50 increments and New Zealand use $200 increments.
d) The computer system then calculates if the rounded value meets set minimum price criteria, based on the booking party, for the region of sale and adjusts accordingly if necessary.

This results in the price for the spare seats. In one possible embodiment, the price is what is charged as an additional fee to the booking for upgrading the booking to one that has the entitlement to one or more multi-person seating spaces during the flight. That is, the standard booking will comprise a number of passengers, each with a reservation and a price allocated to that reservation. That gives each passenger a seat on the plane. Should that booking party wish to have one or more multi-person seating spaces for use during the flight, they can request that as described above. The price is determined for use of the multi-person seating spaces, and that price is added to the booking as a whole. The use of the one or more multi-person seating spaces then becomes an entitlement for that flight, which entitles the passengers in the booking to exclusive use of the multi-person seating spaces how they wish. Other ways of charging for the multi-person seating space could be implemented.

Next, step 4024 a fee is applied for being reserved the multi-person seating space. Each region of sale has a fee for each configuration of a multi-person seating space, i.e. one, two or three occupants.

Next, step 4025, any minimum values are applied. The values from step 4 and step 5 above are then summed. The sum value for each option is then compared to each regions minimum price criteria and the higher value used and presented to customers as one price for each option offered.

Once steps 4020-4025 are carried out, the multi-person seating space options can be offered with corresponding pricing, step 4010 FIG. 41

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

APPENDIX A

| Total | | | | Seated | | |
|---|---|---|---|---|---|---|
| Pax in | | | | in | | |
| PNR | # Adults | # Children | # MPSS | MPSS | Seating Configuration | Offer |
| 1 | 1 | 0 | 1 | 1 | 1 MPSS for 1 | YES |
| 1 | 0 | 1 | 1 | 1 | 1 MPSS for 1 | YES |
| 2 | 2 | 0 | 1 | 1 | 1 MPSS for 1 & 1 Economy seat | NO |
| 2 | 2 | 0 | 1 | 2 | 1 MPSS for 2 | YES |
| 2 | 2 | 0 | 2 | 2 | 2 MPSSs for 2 | NO |
| 2 | 1 | 1 | 1 | 1 | 1 MPSS for 1 & 1 Economy seat | NO |
| 2 | 1 | 1 | 1 | 2 | 1 MPSS for 2 | YES |
| 2 | 1 | 1 | 2 | 2 | 2 MPSSs for 2 | NO |
| 2 | 0 | 2 | 1 | 1 | 1 MPSS for 1 & 1 Economy seat | NO |
| 2 | 0 | 2 | 1 | 2 | 1 MPSS for 2 | YES |
| 2 | 0 | 2 | 2 | 2 | 2 MPSSs for 2 | NO |
| 3 | 3 | 0 | 1 | 1 | 1 MPSS for 1 & 2 Economy seats | NO |
| 3 | 3 | 0 | 1 | 2 | 1 MPSS for 2 & 1 Economy seat | YES |
| 3 | 3 | 0 | 1 | 3 | 1 MPSS for 3 | NO |
| 3 | 3 | 0 | 2 | 2 | 2 MPSSs for 2 & 1 Economy seat | NO |
| 3 | 3 | 0 | 2 | 3 | 2 MPSSs for 3 | YES |
| 3 | 3 | 0 | 3 | 3 | 3 MPSSs for 3 | NO |
| 3 | 2 | 1 | 1 | 1 | 1 MPSS for 1 & 2 Economy seats | NO |
| 3 | 2 | 1 | 1 | 2 | 1 MPSS for 2 & 1 Economy seat | YES |
| 3 | 2 | 1 | 1 | 3 | 1 MPSS for 3 | YES |
| 3 | 2 | 1 | 2 | 2 | 2 MPSSs for 2 & 1 Economy seat | NO |
| 3 | 2 | 1 | 2 | 3 | 2 MPSSs for 3 | YES |
| 3 | 2 | 1 | 3 | 3 | 3 MPSSs for 3 | NO |
| 3 | 1 | 2 | 1 | 1 | 1 MPSS for 1 & 2 Economy seats | NO |
| 3 | 1 | 2 | 1 | 2 | 1 MPSS for 2 & 1 Economy seat | YES |
| 3 | 1 | 2 | 1 | 3 | 1 MPSS for 3 | YES |
| 3 | 1 | 2 | 2 | 2 | 2 MPSSs for 2 & 1 Economy seat | NO |
| 3 | 1 | 2 | 2 | 3 | 2 MPSSs for 3 | YES |
| 3 | 1 | 2 | 3 | 3 | 3 MPPSs for 3 | NO |
| 3 | 0 | 3 | 1 | 1 | 1 MPSS for 1 & 2 Economy seats | NO |
| 3 | 0 | 3 | 1 | 2 | 1 MPSS for 2 & 1 Economy seat | YES |
| 3 | 0 | 3 | 1 | 3 | 1 MPSS for 3 | YES |
| 3 | 0 | 3 | 2 | 2 | 2 MPSSs for 2 & 1 Economy seat | NO |
| 3 | 0 | 3 | 2 | 3 | 2 MPSSs for 3 | YES |
| 3 | 0 | 3 | 3 | 3 | 3 MPSSs for 3 | NO |
| 4 | 4 | 0 | 1 | 1 | 1 MPSS for 1 & 3 Economy seats | NO |
| 4 | 4 | 0 | 1 | 2 | 1 MPSS for 2 & 2 Economy seats | YES |
| 4 | 4 | 0 | 1 | 3 | 1 MPSS for 3 & 1 Economy seat | NO |
| 4 | 4 | 0 | 2 | 2 | 2 MPSSs for 2 & 2 Economy seats | NO |
| 4 | 4 | 0 | 2 | 3 | 2 MPSSs for 3 & 1 Economy seat | NO |
| 4 | 4 | 0 | 2 | 4 | 2 MPSSs for 4 | YES |
| 4 | 4 | 0 | 3 | 3 | 3 MPSSs for 3 & 1 Economy seat | NO |
| 4 | 4 | 0 | 3 | 4 | 3 MPSSs for 4 | NO |
| 4 | 4 | 0 | 4 | 4 | 4 MPSSs for 4 | NO |
| 4 | 3 | 1 | 1 | 1 | 1 MPSS for 1 & 3 Economy seats | NO |
| 4 | 3 | 1 | 1 | 2 | 1 MPSS for 2 & 2 Economy seats | YES |
| 4 | 3 | 1 | 1 | 3 | 1 MPSS for 3 & 1 Economy seat | YES |
| 4 | 3 | 1 | 2 | 2 | 2 MPSSs for 2 & 2 Economy seats | NO |
| 4 | 3 | 1 | 2 | 3 | 2 MPSSs for 3 & 1 Economy seat | NO |
| 4 | 3 | 1 | 2 | 4 | 2 MPSSs for 4 | YES |
| 4 | 3 | 1 | 3 | 3 | 3 MPSSs for 3 & 1 Economy seat | NO |
| 4 | 3 | 1 | 3 | 4 | 3 MPSSs for 4 | NO |
| 4 | 3 | 1 | 4 | 4 | 4 MPSSs for 4 | NO |
| 4 | 2 | 2 | 1 | 1 | 1 MPSS for 1 & 3 Economy seats | NO |
| 4 | 2 | 2 | 1 | 2 | 1 MPSS for 2 & 2 Economy seats | YES |
| 4 | 2 | 2 | 1 | 3 | 1 MPSS for 3 & 1 Economy seat | YES |
| 4 | 2 | 2 | 2 | 2 | 2 MPSSs for 2 & 2 Economy seats | NO |
| 4 | 2 | 2 | 2 | 3 | 2 MPSSs for 3 & 1 Economy seat | NO |
| 4 | 2 | 2 | 2 | 4 | 2 MPSSs for 4 | YES |
| 4 | 2 | 2 | 3 | 3 | 3 MPSSs for 3 & 1 Economy seat | NO |
| 4 | 2 | 2 | 3 | 4 | 3 MPSSs for 4 | NO |
| 4 | 2 | 2 | 4 | 4 | 4 MPSSs for 4 | NO |
| 4 | 1 | 3 | 1 | 1 | 1 MPSS for 1 & 3 Economy seats | NO |
| 4 | 1 | 3 | 1 | 2 | 1 MPSS for 2 & 2 Economy seats | YES |
| 4 | 1 | 3 | 1 | 3 | 1 MPSS for 3 & 1 Economy seat | YES |
| 4 | 1 | 3 | 2 | 2 | 2 MPSSs for 2 & 2 Economy seats | NO |
| 4 | 1 | 3 | 2 | 3 | 2 MPSSs for 3 & 1 Economy seat | NO |
| 4 | 1 | 3 | 2 | 4 | 2 MPSSs for 4 | YES |
| 4 | 1 | 3 | 3 | 3 | 3 MPSSs for 3 & 1 Economy seat | NO |
| 4 | 1 | 3 | 3 | 4 | 3 MPSSs for 4 | NO |
| 4 | 1 | 3 | 4 | 4 | 4 MPSSs for 4 | NO |
| 4 | 0 | 4 | 1 | 1 | 1 MPSS for 1 & 3 Economy seats | NO |
| 4 | 0 | 4 | 1 | 2 | 1 MPSS for 2 & 2 Economy seats | YES |
| 4 | 0 | 4 | 1 | 3 | 1 MPSS for 3 & 1 Economy seat | YES |
| 4 | 0 | 4 | 2 | 2 | 2 MPSSs for 2 & 2 Economy seats | NO |
| 4 | 0 | 4 | 2 | 3 | 2 MPSSs for 3 & 1 Economy seat | NO |
| 4 | 0 | 4 | 2 | 4 | 2 MPSSs for 4 | YES |
| 4 | 0 | 4 | 3 | 3 | 3 MPSSs for 3 & 1 Economy seat | NO |
| 4 | 0 | 4 | 3 | 4 | 3 MPSSs for 4 | NO |
| 4 | 0 | 4 | 4 | 4 | 4 MPSSs for 4 | NO |

1. A method of allocating aircraft seats for a flight reservation for a flight on an aircraft, the method comprising:
receiving a reservation request for one or more associated passengers for a flight on the aircraft,
receiving a request for at least one multi-person seating space for those passengers, wherein a multi-person seating space comprises at least 3 contiguous seats,
allocating one or more of the associated passengers to a respective seat in a multi-person space (or to the multi-person seating space as a unit) resulting in a seat allocation for the associated passengers comprising at least one multi-person seating space with at least one more seat (spare seat) than the number of passengers allocated to seats in that multi-person seating space, and
allowing the associated passengers exclusive use of the multi-person seating space during the flight.

2. A method according to claim 1 further comprising an inventory of seats for the flight wherein the at least one spare seat is removed from the inventory of seats.

3. A method according to claim 1 wherein the allocation takes place at or near the time of receiving a booking request.

4. A method according to claim 1 wherein the request for at least one multi-person seating space can be received any time prior to check-in.

5. A method according to claim 1 wherein the allocation takes place prior to check-in.

6. A method according to claim 2 wherein the removing of the one or more spare seats from the inventory prevents allocation of those one or more seats to passengers making future flight reservations on the aircraft flight.

7. A method according to claim 1 further comprising providing a ticket for the flight, the ticket specifying the passengers and identifying the multi-person seating space.

8. A method according to claim 1 further comprising:
receiving a check-in request,
providing a boarding pass to each of the associated passengers, each boarding pass showing the seat in the multi-person seating space allocated to the respective passenger, and optionally identifying the multi-person seating space.

9. A method according to claim 1 wherein the multi-person seating space comprises three or more seat pans configured such that a passenger can lie across the seat pans substantially unimpeded.

10. A method according to claim 1 wherein one or more of the seats in the multi-person seating space can be configured with one or more extension surfaces substantially co-planar with each seat pan, which, in combination with the seat pans, provide additional support surface for the associated passengers.

11. A method according to claim 1 wherein allocating associated passengers to a seat in a multi-person space nominally allocates the multi-person seating space to those passengers.

12. A method according to claim 1 wherein three contiguous seats comprising a multi-person seating space are physically configured to form the multi-person seating pace.

13. A method according to claim 1 wherein three contiguous seats comprising a multi-person seating space are nominally set aside as a multi-person seating space for nominal allocation to one or more passengers upon request.

14. A method according to claim 11 wherein the aircraft comprises a plurality of seats, wherein a first portion of the seats are physically configured as a plurality of multi-person seating spaces, and a second portion of the seats are individual seats for individual allocation, the method comprising:
receiving reservation requests along with respective requests for a multi-person seating space and allocating passengers relating to those requests to seats in a respective multi-person seating space,
receiving reservation requests without requests for a multi-person seating space and allocating passengers relating to those reservation requests to individual seats, or, if all the individual seats have been allocated, allocating those passengers to seats in a multi-seat seating space.

15. A system for allocating aircraft seats for a flight reservation for a flight on an aircraft comprising:
a computer system configured to:
receive a reservation request for one or more associated passengers for a flight on the aircraft,
receive a request for at least one multi-person seating space for those passengers, wherein a multi-person seating space comprises at least 3 contiguous seats, and
allocate one or more of the associated passengers to a respective seat in a multi-person space (or to the multi-person seating space as a unit) resulting in a seat allocation for the associated passengers comprising at least one multi-person seating space with at least one more seat (spare seat) than the number of passengers allocated to seats in that multi-person seating space, the associated passengers having exclusive use of the multi-person seating space during the flight.

16. A system according to claim 15 further comprising a database with an inventory of seats for the flight wherein the computer system is configured to remove the at least one spare seat from the inventory of seats.

17. A method according to claim 15 wherein the allocation takes place at or near the time of receiving a booking request.

18. A system according to claim 15 wherein the computer system allocates seats at or near the time of receiving a booking request.

19. A system according to claim 15 wherein the computer system allocates seats prior to check-in.

20. A system according to claim 16 wherein the removing of the one or more spare seats from the inventory prevents allocation of those one or more seats to passengers making future flight reservations on the aircraft flight.

21. A system according to claim 15 wherein the computer system generates ticket for the flight, the ticket specifying the passengers and identifying the multi-person seating space.

22. A system according to claim 15 further comprising a computer system configured to:
receive a check-in request,
provide a boarding pass to each of the associated passengers, each boarding pass showing the seat in the multi-person seating space allocated to the respective passenger, and optionally identifying the multi-person seating space.

23. A system according to claim 15 wherein the multi-person seating space comprises three or more seat pans configured such that a passenger can lie across the seat pans substantially unimpeded.

24. A system according to claim 15 wherein one or more of the seats in the multi-person seating space can be configured with one or more extension surfaces substantially co-planar with each seat pan, which, in combination with the seat pans, provide additional support surface for the associated passengers.

25. A system according to claim 15 wherein allocating associated passengers to a seat in a multi-person space nominally allocates the multi-person seating space to those passengers.

26. A system according to claim 15 wherein three contiguous seats comprising a multi-person seating space are physically configured to form the multi-person seating pace.

27. A system according to claim 15 claim wherein three contiguous seats comprising a multi-person seating space are nominally set aside as a multi-person seating space for nominal allocation to one or more passengers upon request.

28. A system according to claim 26 wherein the aircraft comprises a plurality of seats, wherein a first portion of the seats are physically configured as a plurality of multi-person seating spaces, and a second portion of the seats are individual seats for individual allocation, the computer system being further configured to:
receive reservation requests along with respective requests for a multi-person seating space and allocating passengers relating to those requests to seats in a respective multi-person seating space,
receive reservation requests without requests for a multi-person seating space and allocating passengers relating to those reservation requests to individual seats, or, if all the individual seats have been allocated, allocating those passengers to seats in a multi-seat seating space.

29. A method of allocating passengers to multi-person seating spaces for a flight reservation for a flight on an aircraft, wherein each multi-person seating space comprises three or more seat pans that can be configured with one or more extension surfaces substantially co-planar with each seat pan, which, in combination with the seat pans, provide additional support surface for the associated passengers, the method comprising:
receiving a reservation request for one or more associated passengers for a flight on the aircraft,
receiving a request for at least one multi-person seating space for those passengers,
allocating one or more of the associated passenger to a respective seat in a multi-person space, or to the multi-person seating space as a unit.

30. A method according to claim 24 wherein if there are one or more seats in the multi-person space not allocated to the passengers, removing the one or more spare seats from the inventory of seats.

31. A system for allocating passengers to multi-person seating spaces for a flight reservation for a flight on an aircraft, wherein each multi-person seating space comprises three or more seat pans that can be configured with one or more extension surfaces substantially co-planar with each seat pan, which, in combination with the seat pans, provide additional support surface for the associated passengers, the system comprising a computer system configured to:
receive a reservation request for one or more associated passengers for a flight on the aircraft,
receive a request for at least one multi-person seating space for those passengers,
allocate one or more of the associated passenger to a respective seat in a multi-person space, or to the multi-person seating space as a unit.

32. A method of allocating aircraft seats for a flight reservation for a flight on an aircraft, wherein there is an inventory of seats for the flight, the method comprising:
receiving a reservation request for one or more associated passengers for a flight on the aircraft,
receiving a request for a couch-style seating space for those passengers, said couch-style seating being nominally set aside as or configured or configurable as a multi-person seating space,
allocating one or more of the associated passengers to the couch-style seating space for the flight.

33. A method according to claim 26 wherein the couch-style seating space comprises 3 or more seat pans configured such that a passenger can lie across the seat pans substantially unimpeded.

34. A system for allocating aircraft seats for a flight reservation for a flight on an aircraft, wherein there is an inventory of seats for the flight, the system comprising a computer system configured to:
receive a reservation request for one or more associated passengers for a flight on the aircraft,
receive a request for a couch-style seating space for those passengers, said couch-style seating being nominally set aside as or configured or configurable as a multi-person seating space,
allocating one or more of the associated passengers to the couch-style seating space for the flight.
